(19) United States
(12) Patent Application Publication
(10) Pub. No.: US 2024/0351944 A1
(43) Pub. Date: Oct. 24, 2024

(54) Durable Coated Article Having a Metal Layer

(71) Applicant: Vitro Flat Glass LLC, Cheswick, PA (US)

(72) Inventors: Maryanne Griffin, Apollo, PA (US); Jessica Smith, Cheswick, PA (US)

(21) Appl. No.: 18/636,404

(22) Filed: Apr. 16, 2024

Related U.S. Application Data
(60) Provisional application No. 63/460,328, filed on Apr. 19, 2023.

(51) Int. Cl. C03C 17/36; C03C 17/22

(52) U.S. Cl. CPC C03C 17/3681; C03C 17/225; C03C 17/3639; C03C 17/3642; C03C 17/3644; C03C 17/366; C03C 2217/256; C03C 2217/258; C03C 2217/27; C03C 2217/281; C03C 2218/10

(57) ABSTRACT

A coated article includes a substrate and a functional coating applied over at least a portion of the substrate, the functional coating including: a first layer over the substrate; a seed layer over the first layer, the seed layer selected from the group consisting of titanium, titanium aluminum, niobium, titanium niobium, stainless steel, mixtures thereof, alloys thereof, and combinations thereof; a metallic layer over the seed layer; a primer layer over the metallic layer, the primer layer selected from the group consisting of titanium, titanium aluminum, niobium, titanium niobium, nickel chromium, stainless steel, mixtures thereof, alloys thereof, and combinations thereof; and a second layer over the primer layer. A method of making the coated article, a method of reducing haze in a coated article, a method of protecting a metallic layer in a coated article, an insulating glass unit, and a windshield are also provided.

### CROSS-REFERENCE TO RELATED APPLICATION

This application claims priority to U.S. Provisional Application No. 63/460,328, filed Apr. 19, 2023, the disclosure of which is incorporated by reference in its entirety.

### BACKGROUND OF THE INVENTION

### Field of the Invention

This invention relates to articles coated with a solar control coating.

### Technical Considerations

Solar control coatings are known in the fields of architectural and vehicle transparencies. These solar control coatings block or filter selected ranges of electromagnetic radiation, such as, in the range of solar infrared or solar ultraviolet radiation, to reduce the amount of solar energy entering a vehicle or building. This reduction of solar energy transmittance helps reduce the load on the cooling units of the vehicle or building.

In automotive applications, the transparency, when used as a windshield or other selected portions of automotive glazings (e.g., the side glazing adjacent in the automobile's front seat position), typically requires a relatively high visible light transmittance, such as, greater than 70 percent or greater than 75 percent, to allow the automobile driver to see out of the vehicle. For architectural applications, the visible light transmittance can be lower. In some architectural applications, it may be desirable to have a reflective outer surface so as to decrease visibility into the building to retain as much privacy as possible, while still allowing visible light to enter the building and also allowing the workers inside the building to see out. Also, these transparencies are typically tempered or heat treated for increased safety.

These solar control coatings are subject to environmental conditions and can change in color and performance as the coating degrades. It would be desirable to produce a solar control coating that maintains its durability, optical properties, and performance.

### SUMMARY OF THE INVENTION

The invention relates to a coated article comprising a substrate. The substrate comprises a first surface and a second surface opposite the first surface. A functional coating is applied over at least a portion of the first surface or the second surface of the substrate. The functional coating comprises: a first layer positioned over at least a portion of the substrate; a seed layer positioned over and in direct contact with at least a portion of the first layer, wherein the seed layer is selected from the group consisting of titanium, titanium aluminum, niobium, titanium niobium, stainless steel, mixtures thereof, alloys thereof, and combinations thereof; a metallic layer positioned over and in direct contact with at least a portion of the seed layer; a primer layer positioned over and in direct contact with at least a portion of the metallic layer, wherein the primer layer is selected from the group consisting of titanium, titanium aluminum, niobium, titanium niobium, nickel chromium, stainless steel, mixtures thereof, alloys thereof, and combinations thereof; and a second layer positioned over and in direct contact with at least a portion of the primer layer.

The invention also relates to a method of making a coated article. A substrate comprising a first surface and a second surface opposite the first surface is provided. A functional coating is formed over at least a portion of the first surface or the second surface. Forming the functional coating comprises: positioning the substrate in a first chamber comprising a first atmosphere, wherein the first atmosphere comprises greater than 0 percent by volume (vol. %) N₂ to less than or equal to 100 vol. % N₂ or greater than 0 vol. % O₂ to less than or equal to 80 vol. % O₂; applying a first layer the first chamber under the first atmosphere over at least a portion of the substrate; moving the substrate into a second chamber comprising a second atmosphere, wherein the second atmosphere comprises not greater than 15 vol. % N₂ and not greater than 5 vol. % O₂; applying a seed layer in the second chamber under the second atmosphere over and in direct contact with at least a portion of the first layer, wherein the seed layer is selected from the group consisting of titanium, titanium aluminum, niobium, titanium niobium, stainless steel, mixtures thereof, alloys thereof, and combinations thereof; moving the substrate into a third chamber comprising a third atmosphere, wherein the third atmosphere comprises not greater than 15 vol. % N₂ and not greater than 5 vol. % O₂; applying a metallic layer in the third chamber under the third atmosphere over and in direct contact with at least a portion of the seed layer; moving the substrate into a fourth chamber comprising a fourth atmosphere, wherein the fourth atmosphere comprises not greater than 15 vol. % N₂ and not greater than 5 vol. % O₂; applying a primer layer in the fourth chamber under the fourth atmosphere over and in direct contact with at least a portion of the metallic layer, wherein the primer layer is selected from the group consisting of titanium, titanium aluminum, niobium, titanium niobium, nickel chromium, stainless steel, mixtures thereof, alloys thereof, and combinations thereof; moving the substrate into a fifth chamber comprising a fifth atmosphere, wherein the fifth atmosphere comprises greater than 0 vol. % N₂ to less than or equal to 100 vol. % N₂ or greater than 0 vol. % O₂ to less than or equal to 80 vol. % O₂; and applying a second layer in the fifth chamber under the fifth atmosphere over and in direct contact with at least a portion of the primer layer.

The invention also relates to an insulating glass unit comprising a first ply comprising a No. 1 surface and a No. 2 surface opposing the No. 1 surface and a second ply comprising a No. 3 surface and a No. 4 surface opposing the No. 3 surface. The second ply is spaced from the first ply, and the first ply and the second ply are connected together. A functional coating is applied over at least a portion of the No. 2 surface or the No. 3 surface, the functional coating comprising: a first layer positioned over at least a portion of the No. 2 surface or the No. 3 surface; a seed layer positioned over and in direct contact with at least a portion of the first layer, wherein the seed layer is selected from the group consisting of titanium, titanium aluminum, niobium, titanium niobium, stainless steel, mixtures thereof, alloys thereof, and combinations thereof; a metallic layer positioned over and in direct contact with at least a portion of the seed layer; a primer layer positioned over and in direct contact with at least a portion of the metallic layer, wherein the primer layer is selected from the group consisting of titanium, titanium aluminum, niobium, titanium niobium, nickel chromium, stainless steel, mixtures thereof, alloys thereof, and combinations thereof; and a second layer positioned over and in direct contact with at least a portion of the primer layer.

The invention also relates to a windshield comprising a first ply comprising a No. 1 surface and a No. 2 surface opposite the No. 1 surface and a second ply comprising a No. 3 surface and a No. 4 surface opposite the No. 3 surface. The first ply and second ply are connected together with an interlayer. A functional coating is applied over at least a portion of the No. 2 or No. 3 surface, the functional coating comprising: a first layer positioned over at least a portion of the No. 2 surface or the No. 3 surface; a seed layer positioned over and in direct contact with at least a portion of the first layer, wherein the seed layer is selected from the group consisting of titanium, titanium aluminum, niobium, titanium niobium, stainless steel, mixtures thereof, alloys thereof, and combinations thereof; a metallic layer positioned over and in direct contact with at least a portion of the seed layer; a primer layer positioned over and in direct contact with at least a portion of the metallic layer, wherein the primer layer is selected from the group consisting of titanium, titanium aluminum, niobium, titanium niobium, nickel chromium, stainless steel, mixtures thereof, alloys thereof, and combinations thereof; and a second layer positioned over and in direct contact with at least a portion of the primer layer.

The invention also relates to a method protecting a metallic layer in a coated article. A substrate comprising a first surface and a second surface opposite the first surface is provided. A functional coating is formed over at least a portion of the first surface or the second surface. Forming the functional coating comprises: positioning the substrate in a first chamber comprising a first atmosphere, wherein the first atmosphere comprises greater than 0 vol. % N₂ to less than or equal to 100 vol. % N₂ or greater than 0 vol. % O₂ to less than or equal to 80 vol. % O₂; applying a first layer in the first chamber under the first atmosphere over at least a portion of the substrate; moving the substrate into a second chamber comprising a second atmosphere, wherein the second atmosphere comprises not greater than 15 vol. % N₂ and not greater than 5 vol. % O₂; applying a seed layer in the second chamber under the second atmosphere over and in direct contact with at least a portion of the first layer, wherein the seed layer is selected from the group consisting of titanium, titanium aluminum, niobium, titanium niobium, stainless steel, mixtures thereof, alloys thereof, and combinations thereof; moving the substrate into a third chamber comprising a third atmosphere, wherein the third atmosphere comprises not greater than 15 vol. % N₂ and not greater than 5 vol. % O₂; applying a metallic layer in the third chamber under the third atmosphere over and in direct contact with at least a portion of the seed layer; moving the substrate into a fourth chamber comprising a fourth atmosphere, wherein the fourth atmosphere comprises not greater than 15 vol. % N₂ and not greater than 5 vol. % O₂; applying a primer layer in the fourth chamber under the fourth atmosphere over and in direct contact with at least a portion of the metallic layer, wherein the primer layer is selected from the group consisting of titanium, titanium aluminum, niobium, and combinations thereof; moving the substrate into a fifth chamber comprising a fifth atmosphere, wherein the fifth atmosphere comprises greater than 0 vol. % N₂ to less than or equal to 100 vol. % N₂ or greater than 0 vol. % O₂ to less than or equal to 80 vol. % O₂; and applying a second layer in the fifth chamber under the fifth atmosphere over and in direct contact with at least a portion of the primer layer.

The invention also relates to a method of reducing haze in a coated article. A substrate comprising a first surface and a second surface opposite the first surface is provided. A functional coating is formed over at least a portion of the first surface or the second surface. Forming the functional coating comprises: positioning the substrate in a first chamber comprising a first atmosphere, wherein the first atmosphere comprises greater than 0 vol. % N₂ to less than or equal to 100 vol. % N₂ or greater than 0 vol. % O₂ to less than or equal to 80 vol. % O₂; applying a first layer in the first chamber under the first atmosphere over at least a portion of the substrate; moving the substrate into a second chamber comprising a second atmosphere, wherein the second atmosphere comprises not greater than 15 vol. % N₂ and not greater than 5 vol. % O₂; applying a seed layer in the second chamber under the second atmosphere over and in direct contact with at least a portion of the first layer, wherein the seed layer is selected from the group consisting of titanium, titanium aluminum, niobium, titanium niobium, stainless steel, mixtures thereof, alloys thereof, and combinations thereof; moving the substrate into a third chamber comprising a third atmosphere, wherein the third atmosphere comprises not greater than 15 vol. % N₂ and not greater than 5 vol. % O₂; applying a metallic layer in the third chamber under the third atmosphere over and in direct contact with at least a portion of the seed layer; moving the substrate into a fourth chamber comprising a fourth atmosphere, wherein the fourth atmosphere comprises not greater than 15 vol. % N₂ and not greater than 5 vol. % O₂; applying a primer layer in the fourth chamber under the fourth atmosphere over and in direct contact with at least a portion of the metallic layer, wherein the primer layer is selected from the group consisting of titanium, titanium aluminum, niobium, titanium niobium, nickel chromium, stainless steel, mixtures thereof, alloys thereof, and combinations thereof; moving the substrate into a fifth chamber comprising a fifth atmosphere, wherein the fifth atmosphere comprises greater than 0 vol. % N₂ to less than or equal to 100 vol. % N₂ or greater than 0 vol. % O₂ to less than or equal to 80 vol. % O₂; and applying a second layer in the fifth chamber under the fifth atmosphere over and in direct contact with at least a portion of the primer layer. The coated article is heated to a temperature of greater than or equal to 1,000° F., wherein the coated article has reduced haze after heating to a temperature of greater than or equal to 1,000° F.

### BRIEF DESCRIPTION OF THE DRAWINGS

FIGS. 1A and 1B are sectional views (not to scale) of the coated articles according to examples of the invention.

FIG. 2 is a side view (not to scale) of an exemplary insulating glass unit (IGU) having a functional coating of the invention.

FIG. 3 is a sectional view (not to scale) of a vehicle transparency having a functional coating of the invention.

FIG. 4 is a schematic view (not to scale) of an exemplary windshield having a functional coating of the invention.

### DESCRIPTION OF THE INVENTION

As used herein, spatial or directional terms, such as “left”, “right”, “inner”, “outer”, “above”, “below”, and the like, relate to the invention as it is shown in the drawing figures. However, it is to be understood that the invention can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims may vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. “A” or “an” refers to one or more.

Further, as used herein, the terms “formed over”, “deposited over”, or “provided over” mean formed, deposited, or provided on but not necessarily in contact with the surface. For example, a coating layer “formed over” a substrate does not preclude the presence of one or more other coating layers or films of the same or different composition located between the formed coating layer and the substrate. Additionally, all documents, such as, but not limited to, issued patents and patent applications, referred to herein are to be considered to be “incorporated by reference” in their entirety. As used herein, the term “film” refers to a coating region of a desired or selected coating composition. A “layer” can comprise one or more “films”, and a “coating” or “coating stack” can comprise one or more “layers”.

The present disclosure is directed to coated article comprising: a substrate comprising a first surface and a second surface opposite the first surface; and a functional coating applied over at least a portion of the first surface or the second surface of the substrate, the functional coating comprising: a first layer positioned over at least a portion of the substrate; a seed layer positioned over and in direct contact with at least a portion of the first layer, wherein the seed layer is selected from the group consisting of titanium, titanium aluminum, niobium, titanium niobium, stainless steel, mixtures thereof, alloys thereof, and combinations thereof; a metallic layer positioned over and in direct contact with at least a portion of the seed layer; a primer layer positioned over and in direct contact with at least a portion of the metallic layer, wherein the primer layer is selected from the group consisting of titanium, titanium aluminum, niobium, titanium niobium, nickel chromium, stainless steel, mixtures thereof, alloys thereof, and combinations thereof; and a second layer positioned over and in direct contact with at least a portion of the primer layer.

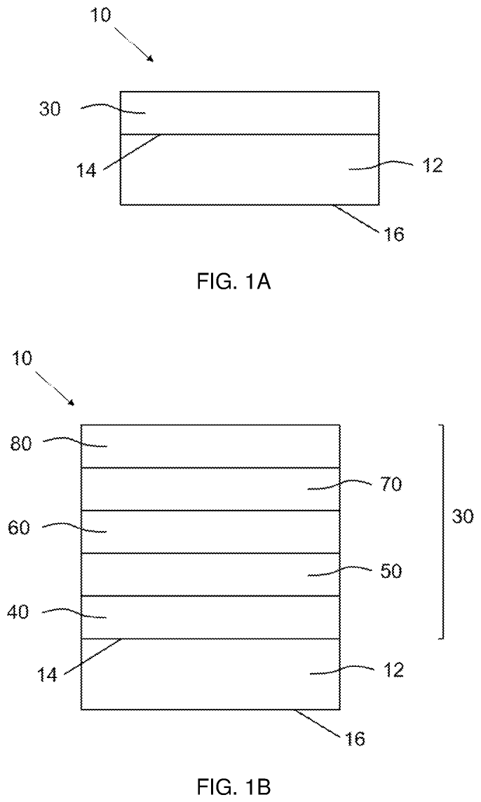

Non-limiting embodiments of a coated article 10 according to the invention are provided in FIGS. 1A and 1B. The coated article 10 comprises a substrate 12 over which a functional coating 30 is applied. The substrate 12 comprises a first surface 14 and a second surface 16 opposite the first surface 14. The functional coating 30 is applied over the first surface 14 or the second surface 16 of the substrate 12. The functional coating 30 comprises a first layer 40 positioned over at least a portion of the substrate 12. The functional coating 30 further comprises a seed layer 50 positioned over and in direct contact with at least a portion of the first layer 40, wherein the seed layer is selected from the group consisting of titanium, titanium aluminum, niobium, titanium niobium, stainless steel, mixtures thereof, alloys thereof, and combinations thereof. The functional coating 30 further comprises a metallic layer 60 positioned over and in direct contact with at least a portion of the seed layer 50. The functional coating 30 further comprises a primer layer 60 positioned over and in direct contact with at least a portion of the metallic layer 50, wherein the primer layer is selected from the group consisting of titanium, titanium aluminum, niobium, titanium niobium, nickel chromium, stainless steel, mixtures thereof, alloys thereof, and combinations thereof. The functional coating 30 further comprises a second layer 70 positioned over and in direct contact with at least a portion of the primer layer 60.

In the broad practice of the invention, the substrate 12 can be of any desired material having any desired characteristics, such as opaque, translucent, or transparent to visible light. For example, the substrate 12 can be transparent or translucent to visible light. By “transparent” is meant having visible light transmission of greater than 0% up to 100%. Alternatively, the substrate 12 can be translucent. By “translucent” is meant allowing electromagnetic energy (e.g., visible light) to pass through but diffusing this energy such that objects on the side opposite the viewer are not clearly visible. Examples of suitable materials include, but are not limited to, plastic substrates (such as acrylic polymers, such as polyacrylates; polyalkylmethacrylates, such as, polymethylmethacrylates, polyethylmethacrylates, polypropylmethacrylates, and the like; polyurethanes; polycarbonates; polyalkylterephthalates, such as polyethyleneterephthalate (PET), polypropyleneterephthalates, polybutyleneterephthalates, and the like; polysiloxane-containing polymers; or copolymers of any monomers for preparing these, or any mixtures thereof); ceramic substrates; glass substrates; or mixtures or combinations of any of the above. For example, the substrate 12 can include conventional soda-lime-silicate glass, borosilicate glass, or leaded glass. The glass can be clear glass. By “clear glass” is meant non-tinted or noncolored glass. Alternatively, the glass can be tinted or otherwise colored glass. The glass can be annealed or heat-treated glass. As used herein, the term “heat treated” means tempered or at least partially tempered. The glass can be of any type, such as conventional float glass, and can be of any composition having any optical properties, e.g., any value of visible transmission, ultraviolet transmission, infrared transmission, and/or total solar energy transmission. By “float glass” is meant glass formed by a conventional float process in which molten glass is deposited onto a molten metal bath and controllably cooled to form a float glass ribbon. Examples of float glass processes are disclosed in U.S. Pat. Nos. 4,466,562 and 4,671,155.

The substrate 12 may comprise, for example, clear float glass or can be tinted or colored glass. The substrate 12 can be of any desired dimensions, e.g., length, width, shape, or thickness. In one non-limiting embodiment in which the article is a vehicle transparency, the substrate may be 1 mm to 10 mm thick, such as 1 mm to 8 mm thick, such as 2 mm to 8 mm, such as 3 mm to 7 mm, such as 5 mm to 7 mm, such as 4 mm to 6 mm thick. In one non-limiting embodiment in which the substrate is an architectural transparency, the substrate 12 may be 1 mm to 30 mm thick, such as 2.5 mm to 25 mm thick, such as 2.5 mm to 10 mm.

The functional coating 30 described herein is a solar control coating. As used herein, the term “solar control coating” refers to a coating comprised of one or more layers or films that affect the solar properties of the coated article, such as, but not limited to, the amount of solar radiation, for example, visible, infrared (IR), or ultraviolet (UV) radiation, reflected from, absorbed by, or passing through the coated article; shading coefficient; emissivity, etc. The solar control coating 30 can block, absorb, or filter selected portions of the solar spectrum, such as, but not limited to the IR, UV, and/or visible spectrums.

In one non-limiting embodiment, functional coating 30 consists of a first layer 40, a seed layer 50, a metallic layer, a primer layer 70, and a second layer 80. In some embodiments, the substrate 12 may only include the functional coating 30. In such instances, the first layer 40, the seed layer 50, the metallic layer 60, the primer layer 70, and the second layer 80 are the only layers of the functional coating 30.

With reference to FIG. 1B, the functional coating 30 comprises a first layer 40 positioned over at least a portion of the first surface 14. In an alternative embodiment, the first layer 40 may be positioned over at least a portion of the second surface 16. The first layer 40 of the functional coating 30 may comprise metal oxides, oxides of metal alloys, metal nitrides, metal oxynitrides, oxynitrides of metal alloys, or mixtures thereof. Examples of suitable materials for the first layer 40 include zinc stannate, zinc oxide, aluminum zinc oxide, tin oxide, silicon nitride, silicon aluminum nitride, silicon oxynitride, silicon aluminum oxynitride, and mixtures thereof. The first layer 40 can be substantially a single phase film, such as a metal alloy oxide film, e.g. zinc stannate, such as a metal nitride film, e.g. silicon nitride, or such as a metal alloy nitride film, e.g. silicon aluminum nitride, or can be a mixture of phases composed of zinc and tin oxides or can be composed of a plurality of films.

The first layer 40 may comprise a zinc stannate film. By “zinc stannate” is meant a composition of Zn_{X}Sn_{1-X}O_{2-X} (Formula 1) where “x” varies in the range of greater than 0 to less than 1. For instance, “x” can be greater than 0 and can be any fraction or decimal between greater than 0 to less than 1. For example, where x=2/3, Formula 1 is Zn_{2/3}Sn_{1/3}O_{4/3}, which is more commonly described as “Zn₂SnO₄”. A zinc stannate-containing film has one or more of the forms of Formula 1 in a predominant amount in the layer.

The first layer 40 may comprise a zinc oxide film. Zinc oxide can be deposited from a zinc target that includes other materials to improve the sputtering characteristics of the target. As such, the zinc oxide can be obtained from magnetron sputtering vacuum deposition from a target of zinc and tin. For example, the zinc target can include a small amount (e.g., up to 20 weight percent (wt. %), up to 15 wt. %, up to 10 wt. %, or up to 5 wt. %) of tin to improve sputtering. In which case, the resultant zinc oxide film would include a small percentage of tin oxide, e.g., up to 10 wt. % tin oxide, e.g., up to 5 wt. % tin oxide. One non-limiting target can comprise zinc and tin in proportions of from 5 wt. % to 95 wt. % zinc and from 95 wt. % to 5 wt. % tin, such as, from 10 wt. % to 90 wt. % zinc and from 90 wt. % to 10 wt. % tin. By “zinc oxide” is meant a coating layer deposited from a zinc target having up to 10 wt. % tin (added to enhance the conductivity of the target). However, other ratios of zinc to tin could also be used.

The first layer 40 may comprise an aluminum zinc oxide film (AlxZn1-x oxide). By “aluminum/zinc alloy oxide” is meant both true alloys, and mixtures of the oxides. As such, the aluminum/zinc alloy oxide can be obtained from magnetron sputtering vacuum deposition from a target of zinc and aluminum and can include a small of amount (e.g. less than 10 wt. %, such as, greater than 0 to 5 wt. %) of tin to improve sputtering. In which case, the resultant aluminum zinc oxide film would include a small percentage of tin oxide, e.g. 0 wt. % to less than 10 wt. %, e.g., 0 wt. % to 5 wt. % tin oxide. The first layer 40 can comprise AlxZn1-x oxide, where x is within the range of 1 wt. % to 25 wt. %, such as, 1 wt. % to 15 wt. %, such as, 1 wt. % to 10 wt. %, such as, 2 wt. % to 5 wt. %. In one non-limiting embodiment, x is 3 wt. %.

The first layer 40 may comprise a tin oxide film. The tin oxide can be deposited from a tin target or from a tin target that includes other materials to improve the sputtering characteristics of the target. The tin oxide can be obtained from magnetron sputtering vacuum deposition from a target of tin or a target of tin and zinc. For example, the tin target can include a small amount (e.g., up to 20 wt. %, up to 15 wt. %, up to 10 wt. %, or up to 5 wt. %) of zinc. In which case, the resultant tin oxide film would include a small percentage of zinc oxide, e.g., up to 20 wt. % zinc oxide, e.g., up to 10 wt. % zinc oxide, e.g., up to 5 wt. % zinc oxide. A coating layer deposited from a tin target having up to from 0 wt. % to 20 wt. % zinc is referred to herein as “a tin oxide film”. The first layer 40 may be a tin oxide film where tin is substantially the only metal in the first layer 40. As used herein, “substantially free” means that the tin oxide film contains less than 0.5 wt. % of additional metals other than tin. The tin oxide film of the first layer 40 may include 80 wt. % tin oxide and 20 wt. % zinc oxide. The tin oxide film of the first layer 40 may include 90 wt. % tin oxide and 10 wt. % zinc oxide.

The first layer 40 can comprise silicon nitride and be sputtered from a single cathode containing silicon. The first layer 40 can comprise silicon aluminum nitride and be sputtered from two cathodes (e.g., one silicon and one aluminum) or from a single cathode containing both silicon and aluminum. The first layer 40 can be silicon aluminum nitride comprising from 5 wt. % to 20 wt. % aluminum and 95 wt. % to 80 wt. % silicon, such as 10 wt. % to 20 wt. % aluminum and 90 wt. % to 80 wt. % silicon, such as 20 wt. % to 25 wt. % aluminum and 80 wt. % to 75 wt. % silicon. The first layer 40 may be silicon nitride comprising silicon. The first layer 40 may be silicon aluminum nitride comprising silicon and aluminum in amount of at least 95 wt. % silicon and at least 5 wt. % aluminum. The first layer 40 may be silicon aluminum nitride comprising silicon and aluminum in an amount of at least 90 wt. % silicon and at least 10 wt. % aluminum. The first layer 40 may silicon aluminum nitride comprising silicon and aluminum in an amount of at least 85 wt. % silicon and at least 15 wt. % aluminum. The first layer 40 may be silicon aluminum nitride comprising silicon and aluminum in an amount of at least 80 wt. % silicon and at least 20 wt. % aluminum. The first layer 40 may be silicon aluminum nitride comprising silicon and aluminum in an amount of at least 75 wt. % silicon and at least 25 wt. % aluminum.

The first layer 40 can be formed by sputtering the metal or metal alloy in a nitrogen (N₂) atmosphere that has a specific flow rate as to form an atmosphere of greater than 0 vol. % N₂ to less than or equal to 100 vol. % N₂. The first layer 40 can be formed by sputtering the metal or metal alloy in an oxygen (O₂) atmosphere that has a specific flow rate as to form an atmosphere of greater than 0 vol. % O₂ to less than or equal to 80 vol. % O₂. The flow rate is an approximation to the amount of N₂ or O₂ in the atmosphere, but one of ordinary skill in the art would recognize that N₂ and/or O₂ may leak into the coating chamber if there are any leaks from the external atmosphere into the coating chamber. For example, the N₂ flow rate (i.e. the concentration of N₂ in the atmosphere for the chamber where the material is being deposited) in the coating chamber can be in the range of 10% to 100%, such as 20% to 100%, such as 30% to 100%, such as 40% to 100%, such as 50% to 100%, such as 20% to 80%, such as 30% to 70%, or such as 40% to 60%. The O₂ flow rate (i.e. the concentration of O₂ in the atmosphere for the chamber where the material is being deposited) in the coating chamber can be greater than 0%, such as in the range of 0% to 50%, such as 10% to 50%, such as 20% to 30%, such as 20% to 40%, such as 20% to 50%, such as 30% to 40%, such as 30% to 50%. Alternatively, the O2 flow rate can be up to 80% O2, such as, 80% O2, 75% O2, or 70% O2. For example, the O₂ flow rate may be from 70% O₂ to 80% O₂. The remainder of the atmosphere in either case (N₂ or O₂ atmosphere) can be an inert gas, such as, argon.

The first layer 40 can be sputtered in the N₂-containing atmosphere such that the deposited first layer 40 comprises a stoichiometric film. The first layer 40 can be sputtered in the O₂-containing atmosphere such that the deposited first layer 40 comprises a stoichiometric film. For example, the first layer 40 can be a stoichiometric silicon nitride film or a stoichiometric silicon aluminum nitride film.

When the first layer 40 comprises silicon nitride or silicon aluminum nitride, the atomic ratio of nitrogen in the first layer 40 can vary, from at least 45 atomic percent (at. %) to not more than 60 at. %, such as at least 50 at. % to not more than 60 at. %, such as at least 55 at. % to not more than 60 at. %, where at. % refers to the ratio of the moles of nitrogen to the total moles of the film composition. When the first layer 40 comprises silicon nitride or silicon aluminum nitride, the first layer 40 may comprise at least 25 wt. % nitrogen and not more than 65 wt. % nitrogen, or at least 30 wt. % nitrogen and not more than 55 wt. % nitrogen, or at least 35 wt. % nitrogen and not more than 50 wt. % nitrogen, or at least 35 wt. % nitrogen and not more than 45 wt. % nitrogen, or at least 35 wt. % and not more than 40 wt. % nitrogen.

One of ordinary skill in the art would recognize that the first layer 40 may contain unintentional elements. The unintentional elements may be incorporated into the first layer 40 such as, through equipment malfunction of the coater or cross contamination of the process chambers. For example, O₂ or N₂ may leak into the coating chamber if there are any leaks from the external atmosphere into the coating chamber.

In one non-limiting embodiment, the first layer 40 comprises at least 90 at. % silicon aluminum nitride or silicon nitride and not more than 10 at. % combined oxygen or species other than silicon, aluminum, and nitrogen; such as, at least 92 at. % silicon aluminum nitride or silicon nitride and not more than 8 at. % combined oxygen or species other than silicon, aluminum, and nitrogen; such as, at least 94 at. % silicon aluminum nitride or silicon nitride and not more than 6 at. % combined oxygen or species other than silicon, aluminum, and nitrogen; such as, at least 96 at. % silicon aluminum nitride or silicon nitride and not more than 4 at. % combined oxygen or species other than silicon, aluminum, and nitrogen; such as, at least 97 at. % silicon aluminum nitride or silicon nitride and not more than 3 at. % combined oxygen or species other than silicon, aluminum, and nitrogen; such as, at least 98 at. % silicon aluminum nitride or silicon nitride and not more than 2 at. % combined oxygen or species other than silicon, aluminum, and nitrogen; or such as, at least 99 at. % silicon aluminum nitride or silicon nitride and not more than 1 at. % combined oxygen or species other than silicon, aluminum, and nitrogen.

The first layer 40 can comprise a total thickness of from 10 nanometers (nm) to 45 nm, such as from 15 nm to 40 nm, such as from 20 to 35 nm, such as from 25 nm to 30 nm.

With reference to FIG. 1B, the functional coating 30 further comprises a seed layer 50 positioned over and in direct contact with the first layer 40. The seed layer 50 is adjacent to and in direct contact with the metallic layer 60 and is between the first layer 40 and the metallic layer 60. Without being bound by theory, the seed layer 50 helps to promote two dimensional growth and increase the density of the metallic layer 60, which is positioned above the seed layer 50, due to its high surface energy. The high surface energy (high Gibbs free energy, high surface tension) stops metal agglomeration of the metallic layer 60 from occurring during growth and heating processes. The seed layer 50 is selected from the group consisting of titanium, titanium aluminum, niobium, titanium niobium, stainless steel, mixtures thereof, alloys thereof, and combinations thereof. The seed layer 50 may be selected from the group consisting of titanium, titanium aluminum, niobium, titanium niobium, mixtures thereof, alloys thereof, and combinations thereof. The seed layer 50 may be selected from the group consisting of titanium, titanium aluminum, niobium, stainless steel, mixtures thereof, alloys thereof, and combinations thereof. The seed layer 50 may comprise titanium. The seed layer 50 may comprise titanium aluminum. The seed layer 50 may comprise niobium. These materials of the seed layer 50 can prevent the migration of the metal from the metallic layer 60 during heating processes.

The seed layer 50 may comprise titanium aluminum. The seed layer 50 may comprise from 30 wt. % to 50 wt. % titanium and from 50 wt. % to 70 wt. % aluminum, such as from 35 wt. % to 50 wt. % titanium and from 50 wt. % to 65 wt. % aluminum, such as from 40 wt. % to 50 wt. % titanium and from 50 wt. % to 60 wt. % aluminum, such as from 45 wt. % to 50 wt. % titanium and from 50 wt. % to 55 wt. % aluminum, or such 50 wt. % titanium and 50 wt. % aluminum. The seed layer 50 comprising titanium aluminum may be sputtered from two cathodes (e.g., one titanium and one aluminum) or from a single cathode containing both titanium and aluminum.

The seed layer 50 may comprise from 40 wt. % to 60 wt. % titanium and from 40 wt. % to 60 wt. % aluminum, such as from 45 wt. % to 55 wt. % titanium and from 45 wt. % to 55 wt. % aluminum, or such as from 47 wt. % to 53 wt. % titanium and from 47 wt. % to 53 wt. % aluminum. The seed layer 50 comprising titanium aluminum may be sputtered from two cathodes (e.g., one titanium and one aluminum) or from a single cathode containing both titanium and aluminum.

One having ordinary skill in the art would recognize that unintentional elements may be incorporated into the seed layer 50. The unintentional elements may be incorporated into the seed layer 50 such as, through equipment malfunction of the coater or cross contamination of the process chambers. For example, O₂ and/or N₂ may leak into the coating chamber if there are any leaks from the external atmosphere into the coating chamber. In one non-limiting embodiment, when the seed layer 50 is titanium aluminum, the seed layer 50 comprises at least 90 at. % titanium aluminum and not more than 10 at. % combined oxygen, nitrogen, or species other than titanium and aluminum; such as, at least 95 at. % titanium aluminum and not more than 5 at. % combined oxygen, nitrogen, or species other than titanium aluminum; such as, at least 97 at. % titanium aluminum and not more than 3 at. % combined oxygen, nitrogen, or species other than titanium and aluminum; such as, at least 99 at. % titanium aluminum and not more than 1 at. % combined oxygen, nitrogen, or species other than titanium and aluminum; or such as, 100 at. % titanium aluminum and 0 at. % combined oxygen, nitrogen, or species other than titanium aluminum. In one non-limiting embodiment, when the seed layer 50 is titanium, the seed layer 50 comprises at least 90 at. % titanium and not more than 10 at. % combined oxygen, nitrogen, or species other than titanium; such as, at least 95 at. % titanium and not more than 5 at. % combined oxygen, nitrogen, or species other than titanium; such as, at least 97 at. % titanium and not more than 3 at. % combined oxygen, nitrogen, or species other than titanium; such as, at least 99 at. % titanium and not more than 1 at. % combined oxygen, nitrogen, or species other than titanium; or such as, 100 at. % titanium and 0 at. % combined oxygen, nitrogen, or species other than titanium. The seed layer 50 may be deposited in an atmosphere that comprises greater than 0 vol. % N₂ but not greater than 15 vol. % N₂, such as not greater than 10 vol. % N₂, or such as not greater than 5 vol. % N₂, without impacting the final the color, adhesion, haze, and sheet resistance of the coated article 10. The seed layer 50 may be deposited in an atmosphere that comprises greater than 0 vol. % O₂ but not greater than 5 vol. % O₂, such as not greater than 2 vol. % O₂, or such as not greater than 1 vol. % O₂, without impacting the final the color, adhesion, haze, and sheet resistance of the coated article 10.

The seed layer 50 can comprise a total thickness of from 0.5 nm to 3 nm, such as from 0.5 nm to 2.5 nm, such as from 1 nm to 2 nm. In one non-limiting embodiment, the seed layer 50 is a titanium layer and has a total thickness of from 0.5 nm to 3 nm, such as from 0.5 nm to 2.5 nm, or such as from 1 nm to 2 nm. In one non-limiting embodiment, the seed layer 50 is titanium aluminum comprising from 45 wt. % to 50 wt. % titanium and from 50 wt. % to 55 wt. % aluminum, such as 50 wt. % titanium and 50 wt. % aluminum, and has a total thickness of from 0.5 nm to 3 nm, such as from 0.5 nm to 2.5 nm, or such as from 1 nm to 2 nm.

With reference to FIG. 1B, the functional coating 30 further comprises a metallic layer 60 positioned over and in direct contact with the seed layer 50. The metallic layer 60 is adjacent to and in direct contact with the seed layer 50 and is between the seed layer 50 and primer layer 70. The metallic layer 60 can include a reflective metal, such as, but not limited to metallic gold, copper, silver, aluminum, or mixtures, alloys, or combinations thereof. The metallic layer 60 may be a metallic silver layer. The metallic layer 60 may be a continuous layer, such as a continuous silver layer. By “continuous layer” is meant that the coating layer forms a continuous film of the material and not isolated coating regions. The metallic layer 60 may be deposited in an atmosphere that comprises greater than 0 vol. % N₂ but not greater than 15 vol. % N₂, such as not greater than 10 vol. % N₂, or such as not greater than 5 vol. % N₂, without impacting the final the color, adhesion, haze, and sheet resistance of the coated article 10. The metallic layer 60 may be deposited in an atmosphere that comprises greater than 0 vol. % O₂ but not greater than 5 vol. % O₂, such as not greater than 2 vol. % O₂, or such as not greater than 1 vol. % O₂, without impacting the final the color, adhesion, haze, and sheet resistance of the coated article 10.

The metallic layer 60 may have a thickness in the range of from 5 nm to 20 nm, such as from 5 nm to 15 nm, such as from 6 nm to 12 nm, such as from 8 nm to 10 nm. In one non-limiting embodiment, the metallic layer 60 is a silver layer and has a thickness in the range of from 5 nm to 20 nm, such as from 5 nm to 15 nm, such as from 6 nm to 12 nm, such as from 8 nm to 10 nm.

With reference to FIG. 1B, the functional coating 30 further comprises a primer layer 70 positioned over and in direct contact with the metallic layer 60. The primer layer 70 is adjacent to and in direct contact with the metallic layer 60 and is between the metallic layer 60 and second layer 80. The primer layer 70 may include an oxygen-capturing material that can be sacrificial during the deposition process to prevent degradation or oxidation of the metallic layer 60 during the sputtering process or subsequent heating processes. The primer layer 70 can also absorb at least a portion of electromagnetic radiation, such as, visible light, passing through the functional coating 30. The primer layer 70 is selected from the group consisting of titanium, titanium aluminum, niobium, titanium niobium, nickel chromium, stainless steel, mixtures thereof, alloys thereof, and combinations thereof. The primer layer 70 may be selected from the group consisting of titanium, titanium aluminum, niobium, nickel chromium, stainless steel, mixtures thereof, alloys thereof, and combinations thereof when the seed layer 50 is selected from the group consisting of titanium, titanium aluminum, niobium, stainless steel, mixtures thereof, alloys thereof, and combinations thereof. When the seed layer 50 is selected from the group consisting of titanium, titanium aluminum, niobium, stainless steel, mixtures thereof, alloys thereof, and combinations thereof, the primer layer 70 is selected from the group consisting of titanium, titanium aluminum, niobium, nickel chromium, stainless steel, mixtures thereof, alloys thereof, and combinations thereof. In one non-limiting embodiment, the primer layer 70 comprises niobium.

One having ordinary skill in the art would recognize that unintentional elements may be incorporated into the primer layer 70. The unintentional elements may be incorporated into the primer layer 70 such as, through equipment malfunction of the coater or cross contamination of the process chambers. For example, O₂ and/or N₂ may leak into the coating chamber if there are any leaks from the external atmosphere into the coating chamber. In one non-limiting embodiment, when the primer layer 70 is niobium, the primer layer 70 comprises at least 90 at. % niobium and not more than 10 at. % combined oxygen, nitrogen, or species other than niobium; such as, at least 95 at. % niobium and not more than 5 at. % combined oxygen, nitrogen, or species other than niobium; such as, at least 97 at. % niobium and not more than 3 at. % combined oxygen, nitrogen, or species other than niobium; such as, at least 99 at. % niobium and not more than 1 at. % combined oxygen, nitrogen, or species other than niobium; or such as, 100 at. % niobium and 0 at. % combined oxygen, nitrogen, or species other than niobium. The primer layer 70 may be deposited in an atmosphere that comprises greater than 0 vol. % N₂ but not greater than 15 vol. % N₂, such as not greater than 10 vol. % N₂, or such as not greater than 5 vol. % N₂, without impacting the final the color, adhesion, haze, and sheet resistance of the coated article 10. The primer layer 70 may be deposited in an atmosphere that comprises greater than 0 vol. % O₂ but not greater than 5 vol. % O₂, such as not greater than 2 vol. % O₂, or such as not greater than 1 vol. % O₂, without impacting the final the color, adhesion, haze, and sheet resistance of the coated article 10. Typically, one of ordinary skill in the art would not consider the amount of nitrogen and/or oxygen in the primer layer, but the amounts of nitrogen and/or oxygen are considered here to account for possible O₂ and/or N₂ leaks and/or cross contamination.

The primer layer 70 may have a thickness in the range of from 0.5 nm to 3 nm, such as from 0.5 nm to 2.5 nm, or such as from 1 nm to 2 nm. In one non-limiting embodiment, the primer layer 70 is niobium and has a thickness in the range of from 0.5 nm to 3 nm, such as from 0.5 nm to 2.5 nm, or such as from 1 nm to 2 nm.

With reference to FIG. 1B, the functional coating 30 further comprises a second layer 80 positioned over and in direct contact with the primer layer 70. The second layer 80 is the outermost layer of the functional coating 30. The second layer 80 may comprise metal oxides, oxides of metal alloys, metal nitrides, metal oxynitrides, oxynitrides of metal alloys, or mixtures thereof. Examples of suitable materials for the second layer 80 include zinc stannate, zinc oxide, aluminum zinc oxide, tin oxide, silicon nitride, silicon aluminum nitride, silicon oxynitride, silicon aluminum oxynitride, and mixtures thereof, as described above with respect to the first layer 40. The second layer 80 can be substantially a single phase film, such as a metal alloy oxide film, e.g. zinc stannate, such as a metal nitride film, e.g. silicon nitride, or such as a metal alloy nitride film, e.g. silicon aluminum nitride, or can be a mixture of phases composed of zinc and tin oxides or can be composed of a plurality of films.

The second layer 80 can be formed by sputtering the metal or metal alloy in a N₂ atmosphere that has a specific flow rate as to form an atmosphere of greater than 0 vol. % N₂ to less than or equal to 100 vol. % N₂. The second layer 80 can be formed by sputtering the metal or metal alloy in an O₂ atmosphere that has a specific flow rate as to form an atmosphere of greater than 0 vol. % O₂ to less than or equal to 80 vol. % O₂. The flow rate is an approximation to the amount of N₂ or O₂ in the atmosphere, but one of ordinary skill in the art would recognize that N₂ and/or O₂ may leak into the coating chamber if there are any leaks from the external atmosphere into the coating chamber. For example, the N₂ flow rate (i.e. the concentration of N₂ in the atmosphere for the chamber where the material is being deposited) in the coating chamber can be in the range of 10% to 100%, such as 20% to 100%, such as 30% to 100%, such as 40% to 100%, such as 50% to 100%, such as 20% to 80%, such as 30% to 70%, or such as 40% to 60%. The O₂ flow rate (i.e. the concentration of O₂ in the atmosphere for the chamber where the material is being deposited) in the coating chamber can be greater than 0%, such as in the range of 0% to 50%, such as 10% to 50%, such as 20% to 30%, such as 20% to 40%, such as 20% to 50%, such as 30% to 40%, such as 30% to 50%. Alternatively, the O2 flow rate can be up to 80% O2, such as, 80% O2, 75% O2, or 70% O2. For example, the O₂ flow rate may be from 70% O2 to 80% O₂. The remainder of the atmosphere in either case (N₂ or O₂ atmosphere) can be an inert gas, such as, argon.

The second layer 80 can be sputtered in the N₂-containing atmosphere such that the deposited second layer 80 comprises a stoichiometric film. The second layer 80 can be sputtered in the O₂-containing atmosphere such that the deposited second layer 80 comprises a stoichiometric film. For example, the second layer 80 can be a stoichiometric silicon nitride film or a stoichiometric silicon aluminum nitride film.

When the second layer 80 comprises silicon nitride or silicon aluminum nitride, the atomic ratio of nitrogen in the second layer 80 can vary, from at least 45 atomic percent (at. %) to not more than 60 at. %, such as at least 50 at. % to not more than 60 at. %, such as at least 55 at. % to not more than 60 at. %, where at. % refers to the ratio of the moles of nitrogen to the total moles of the film composition. When the second layer 80 comprises silicon nitride or silicon aluminum nitride, the second layer 80 may comprise at least 25 wt. % nitrogen and not more than 65 wt. % nitrogen, or at least 30 wt. % nitrogen and not more than 55 wt. % nitrogen, or at least 35 wt. % nitrogen and not more than 50 wt. % nitrogen, or at least 35 wt. % nitrogen and not more than 45 wt. % nitrogen, or at least 35 wt. % and not more than 40 wt. % nitrogen.

One of ordinary skill in the art would recognize that the second layer 80 may contain unintentional elements. The unintentional elements may be incorporated into the second layer 80 such as, through equipment malfunction of the coater or cross contamination of the process chambers. For example, O₂ and/or N₂ may leak into the coating chamber if there are any leaks from the external atmosphere into the coating chamber.

In one non-limiting embodiment, the second layer 80 may comprise at least 90 at. % silicon aluminum nitride or silicon nitride and not more than 10 at. % combined oxygen or species other than silicon, aluminum, and nitrogen; such as, at least 92 at. % silicon aluminum nitride or silicon nitride and not more than 8 at. % combined oxygen or species other than silicon, aluminum, and nitrogen; such as, at least 94 at. % silicon aluminum nitride or silicon nitride and not more than 6 at. % combined oxygen or species other than silicon, aluminum, and nitrogen; such as, at least 96 at. % silicon aluminum nitride or silicon nitride and not more than 4 at. % combined oxygen or species other than silicon, aluminum, and nitrogen; such as, at least 97 at. % silicon aluminum nitride or silicon nitride and not more than 3 at. % combined oxygen or species other than silicon, aluminum, and nitrogen; such as, at least 98 at. % silicon aluminum nitride or silicon nitride and not more than 2 at. % combined oxygen or species other than silicon, aluminum, and nitrogen; or such as, at least 99 at. % silicon aluminum nitride or silicon nitride and not more than 1 at. % combined oxygen or species other than silicon, aluminum, and nitrogen.

The second layer 80 can comprise a total thickness of from 25 nm to 50 nm, such as from 30 nm to 45 nm, such as from 35 nm to 45 nm, such as from 35 nm to 42 nm, such as from 38 nm to 42 nm.

Additional layers (not shown in the figures) may be applied over the second layer 80. For example, a second seed layer may be applied over the second layer, wherein the second seed layer comprises materials identified as being useable for the first seed layer. A second metallic layer may be applied over the second seed layer, wherein the second metallic layer comprises materials identified as being useable for the first metallic layer. A second primer may be applied over the second metallic layer, wherein the second primer comprises materials identified as being useable for the first primer. A third layer may be applied over the second primer layer, wherein the third layer comprises materials identified as being useable for the first layer. Such an embodiment would be considered a double-metallic layer embodiment.

A further embodiment would be a triple-metallic layer embodiment. In this embodiment, a third seed layer may be applied over the third layer, wherein the third seed layer comprises materials identified as being useable for the first seed layer. A third metallic layer may be applied over the third seed layer, wherein the third metallic layer comprises materials identified as being useable for the first metallic layer. A third primer may be applied over the third metallic layer, wherein the third primer comprises materials identified as being useable for the first primer. A fourth layer may be applied over the third primer layer, wherein the fourth layer comprises materials identified as being useable for the first layer.

A further embodiment would be a quadruple-metallic layer embodiment. In this embodiment, fourth third seed layer may be applied over the fourth layer, wherein the fourth seed layer comprises materials identified as being useable for the first seed layer. A fourth metallic layer may be applied over the fourth seed layer, wherein the fourth metallic layer comprises materials identified as being useable for the first metallic layer. A fourth primer may be applied over the third metallic layer, wherein the fourth primer comprises materials identified as being useable for the first primer. A fifth layer may be applied over the fourth primer layer, wherein the fifth layer comprises materials identified as being useable for the first layer.

The coated article 10 may further comprise an outermost protective coating comprising a protective layer over the functional coating 30 as the outermost coating. For example, the outermost protective coating may be deposited over the second layer 80 in a single-metallic layer functional coating. The outermost protective coating may be deposited over the third layer in a double-metallic layer functional coating. The outermost protective coating may be deposited over the fourth layer in a triple-metallic layer functional coating. The outermost protective coating may be deposited over the fifth layer in a quadruple-metallic layer functional coating.

The outermost protective coating can help protect the underlying coatings from mechanical and chemical attack. The outermost protective coating can be an oxygen barrier coating layer to prevent or reduce the passage of ambient oxygen into the underlying layers of the coating, such as, during heating or bending. The outermost protective coating can be of any desired material or mixture of materials and can be comprised of one or more protective films. The outermost protective coating comprises a protective layer, wherein the protective layer comprises a metal oxide and/or a metal nitride. For example, the protective layer may comprise Si3N4, SiAlN, SiAlON, SiAlO, TiAlO, titania, alumina, silica, zirconia, or combinations thereof. The outermost protective coating may have a total thickness that is greater than 0 nm.

However, it can be appreciated that the coated article 10 may be free of an outermost protective coating. In one embodiment, the surface of the substrate 12 may only include the functional coating 30 (i.e. no outermost protective coating). In such instances, the first layer 40, the seed layer 50, the metallic layer 60, the primer layer 70, and the second layer 80 are the only layers of the functional coating 30.

Any of the layers of the functional coating 30 described herein can be deposited over the substrate 12 by any useful method, such as, but not limited to, conventional chemical vapor deposition (CVD) and/or physical vapor deposition (PVD) methods. Examples of CVD processes include spray pyrolysis. Examples of PVD processes include electron beam evaporation and vacuum sputtering (such as magnetron sputter vapor deposition (MSVD)). Other coating methods could also be used, such as, but not limited to, sol-gel deposition. In one non-limiting embodiment, the functional coating 30 is deposited by MSVD. Examples of MSVD coating devices and methods will be well understood by one of ordinary skill in the art and are described, for example, in U.S. Pat. Nos. 4,379,040; 4,861,669; 4,898,789; 4,898,790; 4,900,633; 4,920,006; 4,938,857; 5,328,768; and 5,492,750.

In one non-limiting embodiment, functional coating 30 comprises a first layer 40 comprising silicon aluminum nitride, a seed layer 50 comprising titanium aluminum, a metallic layer 60 comprising silver, a primer layer 70 comprising niobium, and a second layer 80 comprising silicon aluminum nitride. In another non-limiting embodiment, the functional coating 30 comprises a first layer 40 comprising silicon aluminum nitride, a seed layer 50 comprising 50 wt. % titanium and 50 wt. % aluminum, a metallic layer 60 comprising silver, a primer layer 70 comprising niobium, and a second layer 80 comprising silicon aluminum nitride.

In one non-limiting embodiment, the substrate 12 of the coated article 10 is glass. The coated articles 10 of the present invention may be non-temperable. The coated articles 10 of the present invention may be temperable. In the practice of the invention, it is desired to maintain the color of the coated article 10 before and after tempering.

The present invention is also related to a method of making a coated article 10. A substrate 12 comprising a first surface 14 and a second surface 16 opposite the first surface 14 is provided. The substrate 12 can be any of the substrates as described herein. A functional coating 30 is formed over at least a portion of the first surface 14 or the second surface 16 of the substrate 12, forming the functional coating 30 comprises: positioning the substrate 12 in a first chamber comprising a first atmosphere, wherein the first atmosphere comprises greater than 0 vol. % N₂ to less than or equal to 100 vol. % N₂ or greater than 0 vol. % O₂ to less than or equal to 80 vol. % O₂; applying a first layer 40 in the first chamber under the first atmosphere over at least a portion of the substrate; moving the substrate into a second chamber comprising a second atmosphere, wherein the second atmosphere comprises not greater than 15 vol. % N₂ and not greater than 5 vol. % O₂; applying a seed layer 50 in the second chamber under the second atmosphere over and in direct contact with at least a portion of the first layer 40, where the seed layer 50 is selected from the group consisting of titanium, titanium aluminum, niobium, titanium niobium, stainless steel, mixtures thereof, alloys thereof, and combinations thereof; moving the substrate into a third chamber comprising a third atmosphere, wherein the third atmosphere comprises not greater than 15 vol. % N₂ and not greater than 5 vol. % O₂; applying a metallic layer 60 in the third chamber under the third atmosphere over and in direct contact with at least a portion of the seed layer 50; moving the substrate into a fourth chamber comprising a fourth atmosphere, wherein the fourth atmosphere comprises not greater than 15 vol. % N₂ and not greater than 5 vol. % O₂; applying a primer layer 70 in the fourth chamber under the fourth atmosphere over and in direct contact with at least a portion of the metallic layer 60, wherein the primer layer 70 is selected from the group consisting of titanium, titanium aluminum, niobium, titanium niobium, nickel chromium, stainless steel, mixtures thereof, alloys thereof, and combinations thereof; moving the substrate into a fifth chamber comprising a fifth atmosphere, wherein the fifth atmosphere comprises greater than 0 vol. % to less than or equal to 100 vol. % N₂ or greater than 0 vol. % to less than or equal to 80 vol. % O₂; applying a second layer 80 in the fifth chamber under the fifth atmosphere over and in direct contact with at least a portion of the primer layer 70. The first layer 40 can be any first layer as described herein. The seed layer 50 can be any seed layer as described herein. The metallic layer 60 can be any metallic layer described herein. The primer layer 70 can be any primer layer as described herein. The second layer 80 can be any second layer described herein. The seed layer 50, the metallic layer 60, and the primer layer 80 can be deposited in an atmosphere that comprises not greater than 10 vol. % N₂ or such as not greater than 5 vol. % N₂ and not greater than 2 vol. % O₂ or such as not greater than 1 vol. % O₂.

Some of the atmosphere from one chamber may unintentionally move into another chamber. For example, some of the first atmosphere may move from the first chamber into the second chamber, the third chamber, the fourth chamber, and/or the fifth chamber. Some of the second atmosphere may move from the second chamber into the third chamber, the fourth chamber, and/or the fifth chamber. Some of the third atmosphere may move from the third chamber into the fourth chamber and/or the fifth chamber. Some of the fourth atmosphere may move from the fourth chamber into the fifth chamber.

The present invention also relates to a method of protecting a metallic layer in a coated article 10. A substrate 12 comprising a first surface 14 and a second surface 16 opposite the first surface 14. The substrate 12 can be any of the substrates as described herein. A functional coating 30 is formed over at least a portion of the first surface 14 or the second surface 16 of the substrate 12. Forming the functional coating 30 comprises: positioning the substrate 12 in a first chamber comprising a first atmosphere, wherein the first atmosphere comprises greater than 0 vol. % N₂ to less than or equal to 100 vol. % N₂ or greater than 0 vol. % O₂ to less than or equal to 80 vol. % O₂. The first layer 40 is applied in the first chamber under the first atmosphere over at least a portion of the substrate 12. The first layer 40 can be any first layer as described herein. The substrate 12 is moved into a second chamber comprising a second atmosphere. The second atmosphere comprises not greater than 15 vol. % N₂ and not greater than 5 vol. % O₂. A seed layer 50 is applied in the second chamber under the second atmosphere over and in direct contact with at least a portion of the first layer 40. The seed layer 50 is selected from the group consisting of titanium, titanium aluminum, niobium, titanium niobium, stainless steel, mixtures thereof, alloys thereof, and combinations thereof. The seed layer 50 can be any seed layer as described herein. The substrate 12 is moved into a third chamber comprising a third atmosphere, wherein the third atmosphere comprises not greater than 15 vol. % N₂ and not greater than 5 vol. % O₂. A metallic layer 60 is applied in the third chamber under the third atmosphere over and in direct contact with at least a portion of the seed layer 50. The metallic layer 60 can be any metallic layer described herein. The substrate 12 is moved into a fourth chamber comprising a fourth atmosphere. The fourth atmosphere comprises not greater than 15 vol. % N₂ and not greater than 5 vol. % O₂. A primer layer 70 is applied in the fourth chamber under the fourth atmosphere over and in direct contact with at least a portion of the metallic layer 60. The primer layer 70 is selected from the group consisting of titanium, titanium aluminum, niobium, titanium niobium, nickel chromium, stainless steel, mixtures thereof, alloys thereof, and combinations thereof. The primer layer 70 can be any primer layer as described herein. The substrate 12 is moved into a fifth chamber comprising a fifth atmosphere. The fifth atmosphere comprises greater than 0 vol. % N₂ to less than or equal to 100 vol. % N₂ or greater than 0 vol. % O₂ to less than or equal to 80 vol. % O₂. A second layer 80 is applied in the fifth chamber under the fifth atmosphere over and in direct contact with at least a portion of the primer layer 70. The second layer 80 can be any second layer described herein. The seed layer 50, the metallic layer 60, and the primer layer 80 can be deposited in an atmosphere that comprises not greater than 10 vol. % N₂ or such as not greater than 5 vol. % N₂ and not greater than 2 vol. % O₂ or such as not greater than 1 vol. % O₂.

The present invention also relates to a method of reducing haze in a coated article 10. A substrate 12 comprising a first surface 14 and a second surface 16 opposite the first surface 14. The substrate 12 can be any of the substrates as described herein. A functional coating 30 is formed over at least a portion of the first surface 14 or the second surface 16 of the substrate 12. Forming the functional coating 30 comprises: positioning the substrate 12 in a first chamber comprising a first atmosphere, wherein the first atmosphere comprises greater than 0 vol. % N₂ to less than or equal to 100 vol. % N₂ or greater than 0 vol. % O₂ to less than or equal to 80 vol. % O₂. A first layer 40 is applied in the first chamber under the first atmosphere over at least a portion of the substrate 12. The first layer 40 can be any first layer as described herein. The substrate 12 is moved into a second chamber comprising a second atmosphere, wherein the second atmosphere comprises not greater than 15 vol. % N₂ and not greater than 5 vol. % O₂. A seed layer 50 is applied in the second chamber under the second atmosphere over and in direct contact with at least a portion of the first layer 40. The seed layer 50 is selected from the group consisting of titanium, titanium aluminum, niobium, titanium niobium, stainless steel, mixtures thereof, alloys thereof, and combinations thereof. The seed layer 50 can be any seed layer as described herein. The substrate 12 is moved into a third chamber comprising a third atmosphere. The third atmosphere comprises not greater than 15 vol. % N₂ and not greater than 5 vol. % O₂. A metallic layer 60 is applied in the third chamber under the third atmosphere over and in direct contact with at least a portion of the seed layer 50. The metallic layer 60 can be any metallic layer described herein. The substrate 12 is moved into a fourth chamber comprising a fourth atmosphere. The fourth atmosphere comprises not greater than 15 vol. % N₂ and not greater than 5 vol. % O₂. A primer layer 70 is applied in the fourth chamber under the fourth atmosphere over and in direct contact with at least a portion of the metallic layer 60. The primer layer 70 is selected from the group consisting of titanium, titanium aluminum, niobium, titanium niobium, nickel chromium, stainless steel, mixtures thereof, alloys thereof, and combinations thereof. The primer layer 70 can be any primer layer as described herein. The substrate 12 is moved into a fifth chamber comprising a fifth atmosphere. The fifth atmosphere comprises greater than 0 vol. % N₂ to less than or equal to 100 vol. % N₂ or greater than 0 vol. % O₂ to less than or equal to 80 vol. % O₂. A second layer 80 is applied in the fifth chamber under the fifth atmosphere over and in direct contact with at least a portion of the primer layer 70. The second layer 80 can be any second layer described herein. The coated article is heated to a temperature of greater than or equal to 1,000 degrees fahrenheit (° F.) (641 degrees Celsius (° C.)). The coated article has reduced haze after heating to a temperature of greater than or equal to 1,000° F. The seed layer 50, the metallic layer 60, and the primer layer 80 can be deposited in an atmosphere that comprises not greater than 10 vol. % N₂ or such as not greater than 5 vol. % N₂ and not greater than 2 vol. % O₂ or such as not greater than 1 vol. % O₂.

Haze (i.e., light scattering) may be caused by the presence of scattering centers within the metallic layer. By “scattering center” is meant a branching, tree-like, or dendritic feature in or on the metallic layer or circular agglomerate features at the top of the functional coating or within any one of the layers of the functional coating. For example, the scattering center can be a crystal or a crystal mass. The scattering center can be a void that develops after the metallic layer is heated. These scattering centers may be formed in or on the metallic layer during the heating process, such as heating the coated article to a temperature that is greater than or equal to 1,000° F., such as greater than or equal to 1,050° F., such as greater than or equal to 1,100° F., such as greater than or equal to 1,150° F., such as greater than or equal to 1,185° F. As used herein, this temperature refers to the temperature of the surface of the substrate comprising the functional coating.

The protection of the metallic layer and reduction in haze after heating is accomplished by selecting a seed layer 50 and a primer layer 70 and depositing the functional coating layers 40, 50, 60, 70, 80 as described above. When the coated article is heated to a temperature that is greater than or equal to 1,000° F., such as greater than or equal to 1,050° F., such as greater than or equal to 1,100° F., such as greater than or equal to 1,150° F., such as greater than or equal to 1,185° F., the haze of the coated article is less than the haze of a coated article without the seed layer and without the primer layer of the present invention or a coated article having a seed layer and a primer layer that are different than the seed layer and primer layer of the present invention.

The coated articles described herein can be used in an architectural transparency, such as, but not limited to, an insulating glass unit. As used herein, the term “architectural transparency” refers to any transparency located on a building, such as, but not limited to, windows and sky lights. However, it is to be understood that the coated articles described herein are not limited to use with such architectural transparencies but could be practiced with transparencies in any desired field, such as, but not limited to, laminated or non-laminated residential and/or commercial windows, insulating glass units, and/or transparencies for land, air, space, above water and underwater vehicles. In one aspect or embodiment, the coated articles as described herein are transparencies for use in a vehicle, such as a window or a sunroof. Therefore, it is to be understood that the specifically disclosed exemplary aspects or embodiments are presented simply to explain the general concepts of the invention, and that the invention is not limited to these specific exemplary embodiments. Additionally, while a typical “transparency” can have sufficient visible light transmission such that materials can be viewed through the transparency, the “transparency” need not be transparent to visible light but may be translucent or opaque.

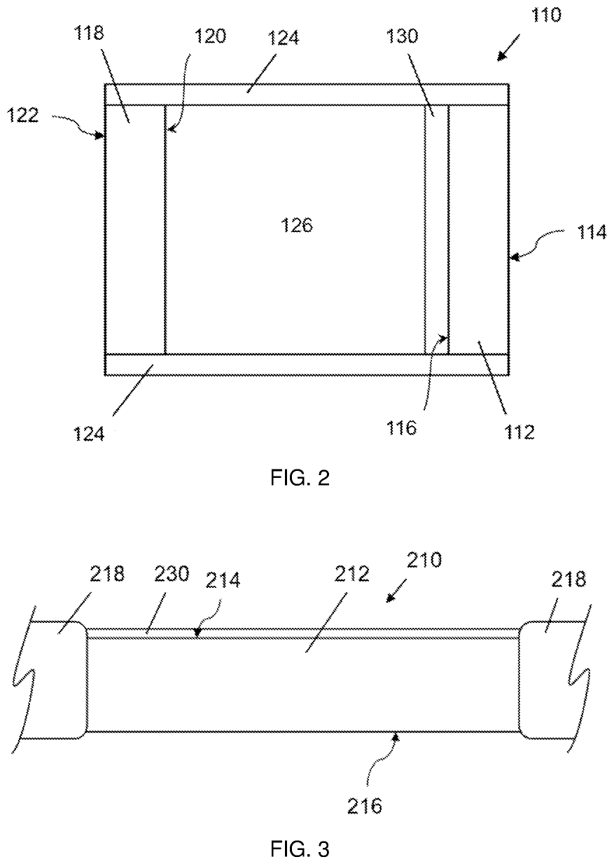

A non-limiting insulating glass unit 110 incorporating the features of the invention is provided in FIG. 2. The insulating glass unit 110 comprises a first ply 112 comprising a No. 1 surface 114 and a No. 2 surface 116 opposing the No. 1 surface 114 and a second ply 118 comprising an inner No. 3 surface 120 and an outer No. 4 surface 122 opposing the No. 3 surface 120. In the illustrated non-limiting embodiment of FIG. 2, the No. 1 surface 114 faces the building exterior, i.e., is an outer surface, and the No. 2 surface 116 faces the interior of the building. The second ply 118 is spaced from the first ply 112, and the first ply 112 and the second ply 118 are connected together. In some embodiments, the insulating glass unit includes a third ply with a No. 5 surface and an opposed No. 6 surface. In some embodiments, one or more of the plies 112, 218 may comprise a laminate structure (e.g., a polymeric interlayer sandwiched between two glass substrates). The plies 112, 118 can have any desired visible light, infrared radiation, or ultraviolet radiation transmission and/or reflection.

The first and second plies 112, 118 can be connected in any suitable manner, such as by being adhesively bonded using a polymeric sealant material to a conventional spacer frame 124. A gap or chamber 126 is formed between the two plies 112, 118. The chamber 126 can be filled with a selected atmosphere, such as, air, or a non-reactive gas such as argon or krypton gas. The functional coating 130 may be formed over at least a portion of the No. 2 surface 118 of the first ply 112 or at least a portion of the No. 3 surface 120 of the second ply 118 or over at least a portion of the No. 5 surface of the optional third ply. The functional 130 may comprise, consist essentially of, or consist of any of the functional coatings described herein.

In broad practice, the plies 112, 118 can be of the same or different materials. The plies 112, 118 can each comprise, for example, clear float glass or can be tinted or colored glass or one ply 112, 118 can be clear glass and the other ply 112, 118 colored glass. Although not limiting, examples of glass suitable for the first ply 112 and/or second ply 118 are described in U.S. Pat. Nos. 4,746,347; 4,792,536; 5,030,593; 5,030,594; 5,240,886; 5,385,872; and 5,393,593.

The functional coating 130 can be formed over at least a portion of the No. 2 surface 116 of a double-glazed insulating glass unit, as shown in FIG. 2. The functional coating 130 can be formed over at least a portion of the No. 3 surface 120 of a double-glazed insulating glass unit. The functional coating 130 can be formed on the No. 2 surface 118 of a triple-glazed insulating glass unit. The functional coating 130 can be formed on the No. 3 surface 120 of a triple-glazed insulating glass unit. The functional coating 130 can be formed on the No. 4 surface 122 of a triple-glazed insulating glass unit. In another non-limiting embodiment, the functional coating 130 can be formed on the No. 5 surface of a triple-glazed insulating glass unit. Examples of insulating glass units are found, for example, in U.S. Pat. Nos. 4,193,236; 4,464,874; 5,088,258; and 5,106,663.

The coated articles described herein can be used in a vehicle transparency, such as a window or a sunroof. A non-limiting vehicle transparency 210 incorporating the features of the invention is provided in FIG. 3. The transparency 210 can include a first ply 212 with a first surface 214 (No. 1 surface) and an opposed second surface 216 (No. 2 surface) mounted in the body of a vehicle 218 (shown in part). The No. 1 surface 214 faces the vehicle's exterior, and thus is an outer surface, and the No. 2 surface 216 faces the interior of the vehicle. For clarity, seals, connectors and opening mechanisms are not shown, nor is the complete vehicle. Non-limiting examples of a vehicle body include: an automobile roof in the case of a sunroof, an automobile door or frame in the case of an automobile window, or a fuselage of an airplane. The transparency 210 may be affixed to a mechanism by which the transparency 210, such as, a car window or sunroof, can be opened and closed, as is broadly known in the vehicular arts. A functional coating 230 can be applied over at least a portion of the No. 1 surface 214, or it may be formed over at least a portion of the No. 2 surface 216, as shown in FIG. 3. The functional coating 230 may comprise, consist essentially of, or consist of any of the functional coatings described herein.

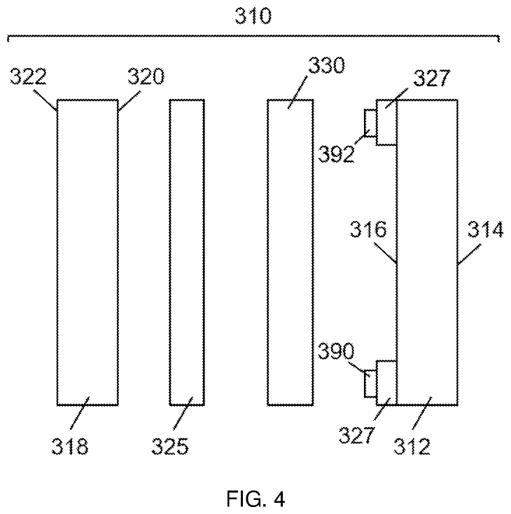

A non-limiting windshield 310 for a vehicle incorporating the features of the invention is provided in FIG. 4. The windshield 310 includes a first ply 312 with a first surface 314 (No. 1 surface) facing the vehicle exterior, i.e., an outer major surface 314 (No. 1 surface), and an opposed second inner surface 316 (No. 2 surface). The windshield also includes a second ply 318 having an outer (first) surface 322 (No. 4 surface) and an inner (second) major surface 320 (No. 3 surface), as shown in FIG. 4. For clarity, seals, connectors and opening mechanisms are not shown, nor is the complete vehicle. This numbering of the ply surfaces is in keeping with conventional practice in the automotive art. The first and second plies 312, 318 can be bonded together in any suitable manner, such as, by conventional interlayer 325. Although not required, a conventional edge sealant can be applied to the perimeter of the laminated article 310 during and/or after lamination in any desired manner. A decorative band, e.g., an opaque, translucent, or colored shade band 327, such as, a ceramic band, can be provided on a surface of at least one of plies 312, 318, for example around the perimeter of the inner major surface 316 of the first ply 312. A functional coating 330 is formed over at least a portion of one of the plies 312, 318, such as, over the No. 2 surface 316 or No. 3 surface 320. The functional coating 330 may comprise, consist essentially of, or consist of any of the functional coatings described herein.

In the non-limiting embodiment illustrated in FIG. 4, the bus bar assembly includes a first or bottom bus bar 390 and a second or top bus bar 392 formed on the inner surface 316 of the outer ply 312 and separated by a bus bar to bus bar distance D. The bus bars 390, 392 are in electrical contact with the functional coating 330. In one non-limiting embodiment of the invention the bus bars 390, 392 can be positioned at least partially on, or completely on, the decorative band 327, as shown in FIG. 4. In the example according to FIG. 4, the functional coating 330 is formed over at least a portion of the inner surface 316 of the outboard glass ply 312; additionally or alternatively, it is to be understood that in non-limiting examples consistent with the present disclosure a functional coating 330 may be formed over at least a portion of the inner surface 320 of the inboard glass ply 318.

In some embodiments, the functional coating can be applied to the surface of a monolithic glazing. By “monolithic” is meant having a single structural support or structural member, e.g., having a single substrate.

The reflected and transmitted aesthetics of the coated article 10, 110, 210, 310 depend upon the physical phenomenon of optical interference of light and in general, are a sensitive function of the optical properties of the materials employed in the functional coating 30, and the sequence of such materials in the functional coating 30. In the practice of the invention, it is desirable that the aesthetics and solar-control performance of the substrates coated with the functional coating 30 described herein exhibits minimal change when the coated substrate is subjected to heat-treatment (e.g., a thermal tempering process). The functional coating 30 can provide other desirable properties to the coated article, such wear resistance.

In the practice of the invention, by selecting a particular thickness and composition for the first layer 40, the seed layer 50, the metallic layer 60, the primer layer 70, and the second layer 80, the absorbed color (e.g., tint) of the coated article 10, 110, 210, 310 can be varied. It is desired to maintain the color of the coated article before and after tempering.

The coated article 10, 110, 210, 310 may have a Shading Coefficient (SC) of less than 0.52, such as less than 0.50, such as 0.48. For example, the coated article may have an SC in the range of from 0.45 to 0.52, such as from 0.48 to 0.50.

The coated article 10, 110, 210, 310 may have a solar heat gain coefficient (SHGC) of less than 0.60, such as less than 0.55, such as less than 0.50. For example, the coated article 10, 110, 210, 310 may have an SHGC in the range of from 0.40 to 0.60, such as from 0.40 to 0.55, such as from 0.40 to 0.50, such as from 0.42 to 0.50.

As used herein, the “U-factor” is the thermal transmittance or rate of transfer of heat through a structure divided by the difference in temperature across said structure. The units for U-Factor include BTU per hour-square feet-degrees fahrenheit (BTU/h-ft2/° F.) or Watts per square meters-Kelvin (W/m2-K). The coated article 10, 110, 210, 310 may have a winter U-factor of less than 0.45 BTU/h·ft2·° F., such as less than 0.40 BTU/h-ft2·° F., such as less than 0.35 BTU/h·ft2·° F. The coated article 10, 110, 210, 310 may have a summer U-factor of less than 0.45 BTU/h·ft2·° F., such as less than 0.40 BTU/h·ft2·° F., such as less than 0.35 BTU/h-ft2·° F.

The coated article 10, 110, 210, 310 may have a light-to-solar gain (LSG) of at least 1.10, such as at least 1.12, such as at least 1.20, such as at least 1.25. The coated article 10, 110, 210, 310 may have a visible transmittance in the range of from 1% to 100%, such as from 30% to 80%, such as from 32% to 75%, such as in the range of from 32% to 70%.

As used herein, “exterior reflectance” is the measure of reflectance of the coated article from the uncoated surface (i.e., the substrate side). The coated article 10, 110, 210, 310 may have an exterior reflectance in the range of from 1% to 50%, such as from 5% to 25%, such as from 10% to 18%.

As used herein, “interior reflectance” is the measure of reflectance of the coated article from the coated surface (i.e., the coating side). The coated article 10, 110, 210, 310 may have an interior reflectance in the range of from 1% to 50%, such as from 5% to 25%, such as from 10% to 22%, such as from 12% to 22%.

The coated article 10, 110, 210, 310 may have transmitted aesthetic CIELAB L*a*b* color value of L* in the range of from 55 to 90, such as from 60 to 85, such as from 63 to 82; a* in the range of from −3.8 to −1.5, such as from −3.6 to −2.0, such as from −3.5 to −2.1; and a b* in the range of from −5.5 to −1.5, such as from −5.0 to −2.0, such as from −4.6 to −2.0.

The coated article 10, 110, 210, 310 may have an exterior reflective aesthetic CIELAB L*a*b* color value (measured from uncoated glass side, Rg) of L* in the range of from 25 to 55, such as from 30 to 50, such as from 33 to 48; a* in the range of from 0.4 to 3.5, such as from 0.5 to 3.0, such as from 0.6 to 3.0; and a b* in the range of from −6.0 to 0.0, such as from −5.8 to −1.0, such as from −5.5 to −1.5.

The coated article 10, 110, 210, 310 may have an interior reflective aesthetic CIELAB L*a*b* color value (measured from coated side, Rf) of L* in the range of from 25 to 65, such as from 28 to 60, such as from 30 to 55, such as from 30 to 52; a* in the range of from 2.0 to 9.0, such as from 2.0 to 8.0, such as from 2.5 to 7.5; and a b* in the range of from 1.0 to 16.0, such as from 3.0 to 15.0, such as from 4.0 to 14.0.

The coated article 10, 110, 210, 310 may have a sheet resistance of from 2.0 Ohms per square (Ω/□) to 30.0Ω/□, such as from 5.0Ω/□ to 12.0Ω/□, such as from 10.0Ω/□ to 12.0Ω/□.

Visible light transmittance, visible light exterior reflectance, visible light interior reflectance, solar transmittance, solar exterior reflectance, solar interior reflectance, and UV transmittance were determined using a Perkin Elmer 1050 Spectrophotometer. Reference values, including Shading Coefficient (SC), Solar Heat Gain Coefficient (SHGC), Light-to-Solar Gain (LSG), unless indicated to the contrary, are those determined in accordance with OPTICS (v6.0) software and WINDOW (v7.6.4) software available from Lawrence Berkeley National Laboratory, measured center of glazing (COG), calculated according to NFRC 2010 (which includes NFRC 100-2010) standard default settings. U-factors, unless indicated to the contrary, are winter/night U-factors. SHGC values, unless indicated to the contrary, are summer/day values. Color values (e.g., L*, a*, b*) are in accordance with the 1976 CIELAB color system specified by the International Commission on Illumination. The L*, a*, b* values in the specification represent color center point values.

The invention is further described in the following numbered clauses:

Clause 1: A coated article comprising: a substrate comprising a first surface and a second surface opposite the first surface; and a functional coating applied over at least a portion of the first surface or the second surface of the substrate, the functional coating comprising: a first layer positioned over at least a portion of the substrate; a seed layer positioned over and in direct contact with at least a portion of the first layer, wherein the seed layer is selected from the group consisting of titanium, titanium aluminum, niobium, titanium niobium, stainless steel, mixtures thereof, alloys thereof, and combinations thereof; a metallic layer positioned over and in direct contact with at least a portion of the seed layer; a primer layer positioned over and in direct contact with at least a portion of the metallic layer, wherein the primer layer is selected from the group consisting of titanium, titanium aluminum, niobium, titanium niobium, nickel chromium, stainless steel, mixtures thereof, alloys thereof, and combinations thereof; and a second layer positioned over and in direct contact with at least a portion of the primer layer.

Clause 2: The coated article of clause 1, wherein the functional coating consists of the first layer, the seed layer, the metallic layer, the primer layer, and the second layer.

Clause 3: The coated article of clause 1 or 2, wherein the seed layer is selected from the group consisting of titanium, titanium aluminum, niobium, titanium niobium, mixtures thereof, alloys thereof, and combinations thereof.

Clause 4: The coated article of clause 1 or 2, wherein the seed layer is selected from the group consisting of titanium, titanium aluminum, niobium, stainless steel, mixtures thereof, alloys thereof, and combinations thereof.

Clause 5: The coated article of any one of clauses 1 to 4, wherein the seed layer comprises titanium.

Clause 6: The coated article of any one of clauses 1 to 4, wherein the seed layer comprises titanium aluminum.

Clause 7: The coated article of clause 6, wherein the seed layer comprises 40 wt. % to 60 wt. % titanium and 40 wt. % to 60 wt. % aluminum, such as such 45 wt. % to 55 wt. % titanium and 45 wt. % to 55 wt. % aluminum, or such as 47 wt. % to 53 wt. % titanium and from 47 wt. % to 53 wt. % aluminum.

Clause 8: The coated article of clause 6, wherein the seed layer comprises 50 wt. % titanium and 50 wt. % aluminum.

Clause 9: The coated article of any one of clauses 1 to 8, wherein the seed layer comprises a thickness in the range of from 0.5 nm to 3 nm, such as from 0.5 nm to 2.5 nm, or such as from 1 nm to 2 nm.

Clause 10: The coated article of any one of clauses 1 to 9, wherein the primer layer is selected from the group consisting of titanium, titanium aluminum, niobium, titanium niobium, stainless steel, mixtures thereof, alloys thereof, and combinations thereof.

Clause 11: The coated article of clause 4, wherein the primer layer is selected from the group consisting of titanium, titanium aluminum, niobium, nickel chromium, stainless steel, mixtures thereof, alloys thereof, and combinations thereof.

Clause 12: The coated article of any one of clauses 1 to 11, wherein the primer layer comprises niobium.

Clause 13: The coated article of any one of clauses 1 to 11, wherein the primer layer comprises titanium.

Clause 14: The coated article of any one of clauses 1 to 13, wherein the primer layer comprises a thickness of from 0.5 nm to 3 nm, such as from 0.5 nm to 2.5 nm, or such as from 1 nm to 2 nm.

Clause 15: The coated article of any one of clauses 1 to 14, wherein the first layer comprises zinc stannate, zinc oxide, aluminum zinc oxide, tin oxide, silicon nitride, silicon aluminum nitride, silicon oxynitride, silicon aluminum oxynitride, or mixtures thereof.

Clause 16: The coated article of any one of clauses 1 to 15, wherein the first layer comprises a thickness in the range of from 10 nm to 45 nm, such as from 20 nm to 35 nm, or such as from 25 nm to 30 nm.

Clause 17: The coated article of any one of clauses 1 to 16, wherein the metallic layer comprises a thickness of from 5 nm to 20 nm, such as from 5 nm to 15 nm, such as from 6 nm to 12 nm, or such as from 8 nm to 10 nm.

Clause 18: The coated article of any one of clauses 1 to 17, wherein the metallic layer comprises silver, gold, palladium, copper, mixtures thereof, alloys thereof, or combinations thereof.

Clause 19: The coated article of any one of clauses 1 to 17, wherein the metallic layer comprises silver.

Clause 20: The coated article of any one of clauses 1 to 19, wherein the metallic layer is a continuous metallic layer.

Clause 21: The coated article of any one of clauses 1 to 20, wherein the seed layer, the metallic layer, and the primer layer are deposited in an atmosphere that comprises nitrogen (N₂) in an amount not greater than 15 vol. % N₂, such as not greater than 10 vol. % N₂, or such as not greater than 5 vol. % N₂ and oxygen (O₂) in an amount not greater than 5 vol. % O₂, such as not greater than 2 vol. % O₂, or such as not greater than 1 vol. % O₂.

Clause 22: The coated article of any one of clauses 1 to 21, wherein the second layer comprises zinc stannate, zinc oxide, aluminum zinc oxide, tin oxide, silicon nitride, silicon aluminum nitride, silicon oxynitride, silicon aluminum oxynitride, or mixtures thereof.

Clause 23: The coated article of any one of clauses 1 to 22, wherein the second layer comprises a thickness in the range of from 25 nm to 50 nm, such as from 30 nm to 45 nm, such as from 35 nm to 42 nm, or such as from 38 nm to 42 nm.

Clause 24: The coated article of any one of clauses 1 to 23, wherein the seed layer comprises titanium aluminum; wherein the metallic layer comprises silver; and wherein the primer layer comprises niobium.

Clause 25: The coated article of any one of clauses 1 to 24, wherein the substrate is glass.

Clause 26: The coated article of any one of clauses 1 to 25, wherein the coated article is temperable.

Clause 27: A method of making a coated article, the method comprising: providing a substrate comprising a first surface and a second surface opposite the first surface; and forming a functional coating over at least a portion of the first surface or the second surface, wherein forming the functional coating comprises: positioning the substrate in a first chamber comprising a first atmosphere, wherein the first atmosphere comprises greater than 0 vol. % N₂ to less than or equal to 100 vol. % N₂ or greater than 0 vol. % O₂ to less than or equal to 80 vol. % O₂; applying a first layer in the first chamber under the first atmosphere over at least a portion of the substrate; moving the substrate into a second chamber comprising a second atmosphere, wherein the second atmosphere comprises not greater than 15 vol. % N₂ and not greater than 5 vol. % O₂; applying a seed layer in the second chamber under a second atmosphere over and in direct contact with at least a portion of the first layer, wherein the seed layer is selected from the group consisting of titanium, titanium aluminum, niobium, titanium niobium, stainless steel, mixtures thereof, alloys thereof, and combinations thereof; moving the substrate into a third chamber comprising a third atmosphere, wherein the third atmosphere comprises not greater than 15 vol. % N₂ and not greater than 5 vol. % O₂; applying a metallic layer in the third chamber under the third atmosphere over and in direct contact with at least a portion of the seed layer; moving the substrate into a fourth chamber comprising a fourth atmosphere, wherein the fourth atmosphere comprises not greater than 15 vol. % N₂ and not greater than 5 vol. % O₂; applying a primer layer in the fourth chamber under the fourth atmosphere over and in direct contact with at least a portion of the metallic layer, wherein the primer layer is selected from the group consisting of titanium, titanium aluminum, niobium, and combinations thereof; moving the substrate into a fifth chamber comprising a fifth atmosphere, wherein the fifth atmosphere comprises greater than 0 vol. % N₂ to less than or equal to 100 vol. % N₂ or greater than 0 vol. % O₂ to less than or equal to 80 vol. % O₂; and applying a second layer in the fifth chamber under a fifth atmosphere over and in direct contact with at least a portion of the primer layer.

Clause 28: The method of clause 27, wherein the seed layer, the metallic layer, and the primer layer are deposited in an atmosphere that comprises not greater than 10 vol. % N₂ or not greater than 5 vol. % N₂ and not greater than 2 vol. % O₂ or not greater than 1 vol. % O₂.

Clause 29: The method of clause 27 or 28, wherein the functional coating consists of the first layer, the seed layer, the metallic layer, the primer layer, and the second layer.

Clause 30: The method of any one of clauses 27 to 29, wherein the seed layer is selected from the group consisting of titanium, titanium aluminum, niobium, titanium niobium, mixtures thereof, alloys thereof, and combinations thereof.

Clause 31: The method of any one of clauses 27 to 29, wherein the seed layer is selected from the group consisting of titanium, titanium aluminum, niobium, stainless steel, mixtures thereof, alloys thereof, and combinations thereof.

Clause 32: The method of any one of clauses 27 to 31, wherein the seed layer comprises titanium.

Clause 33: The method of any one of clauses 27 to 31, wherein the seed layer comprises titanium aluminum.

Clause 34: The method of clause 33, wherein the seed layer comprises 40 wt. % to 60 wt. % titanium and 40 wt. % to 60 wt. % aluminum, such as such 45 wt. % to 55 wt. % titanium and 45 wt. % to 55 wt. % aluminum, or such as 47 wt. % to 53 wt. % titanium and from 47 wt. % to 53 wt. % aluminum.

Clause 35: The method of clause 33, wherein the seed layer comprises 50 wt. % titanium and 50 wt. % aluminum.

Clause 36: The method of any of clauses 27 to 35, wherein the seed layer comprises a thickness in the range of from 0.5 nm to 3 nm, such as from 0.5 nm to 2.5 nm, or such as from 1 nm to 2 nm.

Clause 37: The method of any one of clauses 27 to 36, wherein the primer layer is selected from the group consisting of titanium, titanium aluminum, niobium, titanium niobium, stainless steel, mixtures thereof, alloys thereof, and combinations thereof.

Clause 38: The method of clause 31, wherein the primer layer is selected from the group consisting of titanium, titanium aluminum, niobium, nickel chromium, stainless steel, mixtures thereof, alloys thereof, and combinations thereof.

Clause 39: The method of any one of clauses 27 to 38, wherein the primer layer comprises niobium.

Clause 40: The method of any one of clauses 27 to 38, wherein the primer layer comprises titanium.

Clause 41: The method of any one of clauses 27 to 39, wherein the primer layer comprises a thickness of from 0.5 nm to 3 nm, such as from 0.5 nm to 2.5 nm, or such as from 1 nm to 2 nm.

Clause 42: The method of any one of clauses 27 to 41, wherein the first layer comprises zinc stannate, zinc oxide, aluminum zinc oxide, tin oxide, silicon nitride, silicon aluminum nitride, silicon oxynitride, silicon aluminum oxynitride, or mixtures thereof.

Clause 43: The method of any one of clauses 27 to 42, wherein the first layer comprises a thickness in the range of from 10 nm to 45 nm, such as from 20 nm to 35 nm, or such as from 25 nm to 30 nm.

Clause 44: The method of any one of clauses 27 to 43, wherein the metallic layer comprises a thickness of from 5 nm to 20 nm, such as from 5 nm to 15 nm, such as from 6 nm to 12 nm, or such as from 8 nm to 10 nm.

Clause 45: The method of any one of clauses 27 to 44, wherein the metallic layer comprises silver, gold, palladium, copper, mixtures thereof, alloys thereof, or combinations thereof.

Clause 46: The method of any one of clauses 27 to 44, wherein the metallic layer comprises silver.

Clause 47: The method of any one of clauses 27 to 46, wherein the metallic layer is a continuous metallic layer.

Clause 48: The method of any one of clauses 27 to 47, wherein the second layer comprises zinc stannate, zinc oxide, aluminum zinc oxide, tin oxide, silicon nitride, silicon aluminum nitride, silicon oxynitride, silicon aluminum oxynitride, or mixtures thereof.

Clause 49: The method of any one of clauses 27 to 48, wherein the second layer comprises a thickness in the range of from 25 nm to 50 nm, such as from 30 nm to 45 nm, such as from 35 nm to 42 nm, or such as from 38 nm to 42 nm.

Clause 50: The method of any one of clauses 27 to 49, wherein the seed layer comprises titanium aluminum; wherein the metallic layer comprises silver; and wherein the primer layer comprises niobium.

Clause 51: The method of any one of clauses 27 to 50, wherein the substrate is glass.

Clause 52: The method of any one of clauses 27 to 51, wherein the coated article is temperable.

Clause 53: An insulating glass unit comprising: a first ply comprising a No. 1 surface and a No. 2 surface opposing the No. 1 surface; a second ply comprising a No. 3 surface and a No. 4 surface opposing the No. 3 surface, wherein the first ply and the second ply are connected together; and a functional coating over at least a portion of the No. 2 surface or the No. 3 surface, the functional coating comprising: a first layer positioned over at least a portion of the No. 2 surface or the No. 3 surface; a seed layer positioned over and in direct contact with at least a portion of the first layer, wherein the seed layer is selected from the group consisting of titanium, titanium aluminum, niobium, titanium niobium, stainless steel, mixtures thereof, alloys thereof, and combinations thereof; a metallic layer positioned over and in direct contact with at least a portion of the seed layer; a primer layer positioned over and in direct contact with at least a portion of the metallic layer, wherein the primer layer is selected from the group consisting of titanium, titanium aluminum, niobium, titanium niobium, nickel chromium, stainless steel, mixtures thereof, alloys thereof, and combinations thereof; and a second layer positioned over and in direct contact with at least a portion of the primer layer.

Clause 54: The insulating glass unit of clause 53, wherein the functional coating consists of the first layer, the seed layer, the metallic layer, the primer layer, and the second layer.

Clause 55: The insulating glass unit of clause 53 or 54, wherein the seed layer is selected from the group consisting of titanium, titanium aluminum, niobium, titanium niobium, mixtures thereof, alloys thereof, and combinations thereof.

Clause 56: The insulating glass unit of clause 53 or 54, wherein the seed layer is selected from the group consisting of titanium, titanium aluminum, niobium, stainless steel, mixtures thereof, alloys thereof, and combinations thereof.

Clause 57: The insulating glass unit of any one of clauses 53 to 56, wherein the seed layer comprises titanium.

Clause 58: The insulating glass unit of any one of clauses 53 to 56, wherein the seed layer comprises titanium aluminum.

Clause 59: The insulating glass unit of clause 58, wherein the seed layer comprises 40 wt. % to 60 wt. % titanium and 40 wt. % to 60 wt. % aluminum, such as such 45 wt. % to 55 wt. % titanium and 45 wt. % to 55 wt. % aluminum, or such as 47 wt. % to 53 wt. % titanium and from 47 wt. % to 53 wt. % aluminum.

Clause 60: The insulating glass unit of clause 58, wherein the seed layer comprises 50 wt. % titanium and 50 wt. % aluminum.

Clause 61: The insulating glass unit of any one of clauses 53 to 60, wherein the seed layer comprises a thickness in the range of from 0.5 nm to 3 nm, such as from 0.5 nm to 2.5 nm, or such as from 1 nm to 2 nm.

Clause 62: The insulating glass unit of any one of clauses 53 to 61, wherein the primer layer is selected from the group consisting of titanium, titanium aluminum, niobium, titanium niobium, stainless steel, mixtures thereof, alloys thereof, and combinations thereof.

Clause 63: The insulating glass unit of clause 55, wherein the primer layer is selected from the group consisting of titanium, titanium aluminum, niobium, nickel chromium, stainless steel, mixtures thereof, alloys thereof, and combinations thereof.

Clause 64: The insulating glass unit of any one of clauses 53 to 62, wherein the primer layer comprises niobium.

Clause 65: The insulating glass unit of any one of clauses 53 to 63, wherein the primer layer comprises titanium.

Clause 66: The insulating glass unit of any one of clauses 53 to 65, wherein the primer layer comprises a thickness of from 0.5 nm to 3 nm, such as from 0.5 nm to 2.5 nm, or such as from 1 nm to 2 nm.

Clause 67: The insulating glass unit of any one of clauses to 53 to 66, wherein the first layer comprises zinc stannate, zinc oxide, aluminum zinc oxide, tin oxide, silicon nitride, silicon aluminum nitride, silicon oxynitride, silicon aluminum oxynitride, or mixtures thereof

Clause 68: The insulating glass unit of any one of clauses 53 to 67, wherein the first layer comprises a thickness in the range of from 10 nm to 45 nm, such as from 20 nm to 35 nm, or such as from 25 nm to 30 nm.

Clause 69: The insulating glass unit of any one of clauses 53 to 68, wherein the metallic layer comprises a thickness of from 5 nm to 20 nm, such as from 5 nm to 15 nm, such as from 6 nm to 12 nm, or such as from 8 nm to 10 nm.

Clause 70: The insulating glass unit of any one of clauses 53 to 69, wherein the metallic layer comprises silver, gold, palladium, copper, mixtures thereof, alloys thereof, or combinations thereof.

Clause 71: The insulating glass unit of any one of clauses 53 to 69, wherein the metallic layer comprises silver.

Clause 72: The insulating glass unit of any one of clauses 53 to 71, wherein the metallic layer is a continuous metallic layer.

Clause 73: The insulating glass unit of any one of clauses 53 to 72, wherein the seed layer, the metallic layer, and the primer layer are deposited in an atmosphere that comprises nitrogen (N₂) in an amount not greater than 15 vol. % N₂, such as not greater than 10 vol. % N₂, or such as not greater than 5 vol. % N₂ and not greater than 5 vol. % O₂, such as not greater than 2 vol. % O₂, or such as not greater than 1 vol. % O₂.

Clause 74: The insulating glass unit of any one of clauses 53 to 73, wherein the second layer comprises zinc stannate, zinc oxide, aluminum zinc oxide, tin oxide, silicon nitride, silicon aluminum nitride, silicon oxynitride, silicon aluminum oxynitride, or mixtures thereof.

Clause 75: The insulating glass unit of any one of clauses 53 to 74, wherein the second layer comprises a thickness in the range of from 25 nm to 50 nm, such as from 30 nm to 45 nm, such as from 35 nm to 42 nm, or such as from 38 nm to 42 nm. Clause 76: The insulating glass unit of any one of clauses 53 to 74, wherein

the seed layer comprises titanium aluminum; wherein the metallic layer comprises silver; and wherein the primer layer comprises niobium.

Clause 77: The insulating glass unit of any one of clauses 53 to 76, wherein the first ply and second ply are glass.

Clause 78: The insulating glass unit of any one of clauses 53 to 76, wherein the first ply and the second ply are temperable.

Clause 79: A windshield comprising: a first ply comprising a No. 1 surface and a No. 2 surface opposite the No. 1 surface; a second ply comprising a No. 3 surface and a No. 4 surface opposite the No. 3 surface, wherein the second ply is spaced from the first ply, and wherein the first ply and second ply are connected together with an interlayer; and a functional coating over at least a portion of the No. 2 or No. 3 surface, the functional coating comprising: a first layer positioned over at least a portion of the No. 2 surface or the No. 3 surface; a seed layer positioned over and in direct contact with at least a portion of the first layer, wherein the seed layer is selected from the group consisting of titanium, titanium aluminum, niobium, titanium niobium, stainless steel, mixtures thereof, alloys thereof, and combinations thereof; a metallic layer positioned over and in direct contact with at least a portion of the seed layer; a primer layer positioned over and in direct contact with at least a portion of the metallic layer, wherein the primer layer is selected from the group consisting of titanium, titanium aluminum, niobium, titanium niobium, nickel chromium, stainless steel, mixtures thereof, alloys thereof, and combinations thereof; and a second layer positioned over and in direct contact with at least a portion of the primer layer.

Clause 80: The windshield of clause 79, wherein the functional coating consists of the first layer, the seed layer, the metallic layer, the primer layer, and the second layer.

Clause 81: The windshield of clause 79 or 80, wherein the seed layer is selected from the group consisting of titanium, titanium aluminum, niobium, titanium niobium, mixtures thereof, alloys thereof, and combinations thereof.

Clause 82: The windshield of clause 79 or 80, wherein the seed layer is selected from the group consisting of titanium, titanium aluminum, niobium, stainless steel, mixtures thereof, alloys thereof, and combinations thereof.

Clause 83: The windshield of any one of clauses 79 to 82, wherein the seed layer comprises titanium.

Clause 84: The windshield of any one of clauses 79 to 82, wherein the seed layer comprises titanium aluminum.

Clause 85: The windshield of clause 84, wherein the seed layer comprises 40 wt. % to 60 wt. % titanium and 40 wt. % to 60 wt. % aluminum, such as such 45 wt. % to 55 wt. % titanium and 45 wt. % to 55 wt. % aluminum, or such as 47 wt. % to 53 wt. % titanium and from 47 wt. % to 53 wt. % aluminum.

Clause 86: The windshield of clause 84, wherein the seed layer comprises 50 wt. % titanium and 50 wt. % aluminum.

Clause 87: The windshield of any one of clauses 79 to 86, wherein the seed layer comprises a thickness in the range of from 0.5 nm to 3 nm, such as from 0.5 nm to 2.5 nm, or such as from 1 nm to 2 nm.

Clause 88: The windshield of any one of clauses 79 to 867, wherein the primer layer is selected from the group consisting of titanium, titanium aluminum, niobium, titanium niobium, stainless steel, mixtures thereof, alloys thereof, and combinations thereof.

Clause 89: The windshield of clause 82, wherein the primer layer is selected from the group consisting of titanium, titanium aluminum, niobium, nickel chromium, stainless steel, mixtures thereof, alloys thereof, and combinations thereof.

Clause 90: The windshield of any one of clauses 79 to 89, wherein the primer layer comprises niobium.

Clause 91: The windshield of any one of clauses 79 to 89, wherein the primer layer comprises titanium.

Clause 92: The windshield of any one of clauses 79 to 91, wherein the primer layer comprises a thickness of from 0.5 nm to 3 nm, such as from 0.5 nm to 2.5 nm, or such as from 1 nm to 2 nm.

Clause 93: The windshield of any one of clauses 79 to 92, wherein the first layer comprises zinc stannate, zinc oxide, aluminum zinc oxide, tin oxide, silicon nitride, silicon aluminum nitride, silicon oxynitride, silicon aluminum oxynitride, or mixtures thereof.

Clause 94: The windshield of any one of clauses 79 to 93, wherein the first layer comprises a thickness in the range of from 10 nm to 45 nm, such as from 20 nm to 35 nm, or such as from 25 nm to 30 nm.

Clause 95: The windshield of any one of clauses 79 to 94, wherein the metallic layer comprises a thickness of from 5 nm to 20 nm, such as from 5 nm to 15 nm, such as from 6 nm to 12 nm, or such as from 8 nm to 10 nm.

Clause 96: The windshield of any one of clauses 79 to 95, wherein the metallic layer comprises silver, gold, palladium, copper, mixtures thereof, alloys thereof, or combinations thereof.

Clause 97: The windshield of any one of clauses 79 to 95, wherein the metallic layer comprises silver.

Clause 98: The windshield of any one of clauses 79 to 97, wherein the metallic layer is a continuous metallic layer.

Clause 99: The windshield of any one of clauses 79 to 98, wherein the seed layer, the metallic layer, and the primer layer are deposited in an atmosphere that comprises nitrogen (N₂) in an amount not greater than 15 vol. % N₂, such as not greater than 10 vol. % N₂, or such as not greater than 5 vol. % N₂ and not greater than 5 vol. % O₂, such as not greater than 2 vol. % O₂, or such as not greater than 1 vol. % O₂.

Clause 100: The windshield of any one of clauses 79 to 99, wherein the second layer comprises zinc stannate, zinc oxide, aluminum zinc oxide, tin oxide, silicon nitride, silicon aluminum nitride, silicon oxynitride, silicon aluminum oxynitride, or mixtures thereof.

Clause 101: The windshield of any one of clauses 79 to 100, wherein the second layer comprises a thickness in the range of from 25 nm to 50 nm, such as from 30 nm to 45 nm, such as from 35 nm to 42 nm, or such as from 38 nm to 42 nm.

Clause 102: The windshield of any one of clauses 79 to 101, wherein the seed layer comprises titanium aluminum; wherein the metallic layer comprises silver; and wherein the primer layer comprises niobium.

Clause 103: The windshield of any one of clauses 79 to 102, wherein the first ply and second ply are glass.

Clause 104: The windshield of any one of clauses 79 to 103, wherein the first ply and the second ply are temperable.

Clause 105: A method of protecting a metallic layer in a coated article, the method comprising: providing a substrate comprising a first surface and a second surface opposite the first surface; forming a functional coating over at least a portion of the first surface or the second surface, wherein forming the functional coating comprises: positioning the substrate in a first chamber comprising a first atmosphere, wherein the first atmosphere comprises greater than 0 vol. % N₂ to less than or equal to 100 vol. % N₂ or greater than 0 vol. % O₂ to less than or equal to 80 vol. % O₂; applying a first layer in the first chamber under the first atmosphere over at least a portion of the substrate; moving the substrate into a second chamber comprising a second atmosphere, wherein the second atmosphere comprises not greater than 15 vol. % N₂ and not greater than 5 vol. % O₂; applying a seed layer in the second chamber under the second atmosphere over and in direct contact with at least a portion of the first layer, wherein the seed layer is selected from the group consisting of titanium, titanium aluminum, niobium, titanium niobium, stainless steel, mixtures thereof, alloys thereof, and combinations thereof; moving the substrate into a third chamber comprising a third atmosphere, wherein the third atmosphere comprises not greater than 15 vol. % N₂ and not greater than 5 vol. % O₂; applying a metallic layer in the third chamber under the third atmosphere over and in direct contact with at least a portion of the seed layer; moving the substrate into a fourth chamber comprising a fourth atmosphere, wherein the fourth atmosphere comprises not greater than 15 vol. % N₂ and not greater than 5 vol. % O₂; applying a primer layer in the fourth chamber under the fourth atmosphere over and in direct contact with at least a portion of the metallic layer, wherein the primer layer is selected from the group consisting of titanium, titanium aluminum, niobium, titanium niobium, nickel chromium, stainless steel, mixtures thereof, alloys thereof, and combinations thereof; moving the substrate into a fifth chamber comprising a fifth atmosphere, wherein the fifth atmosphere comprises greater than 0 vol. % N₂ to less than or equal to 100 vol. % N₂ or greater than 0 vol. % O₂ to less than or equal to 80 vol. % O₂; and applying a second layer in the fifth chamber under the fifth atmosphere over and in direct contact with at least a portion of the primer layer.

Clause 106: The method of clause 105, wherein the seed layer, the metallic layer, and the primer layer are deposited in an atmosphere that comprises not greater than 10 vol. % N₂ or not greater than 5 vol. % N₂ and not greater than 2 vol. % O₂ or not greater than 1 vol. % O₂.

Clause 107: The method of clause 105 or 106, wherein the functional coating consists of the first layer, the seed layer, the metallic layer, the primer layer, and the second layer.

Clause 108: The method of any one of clauses 105 to 107, wherein the seed layer is selected from the group consisting of titanium, titanium aluminum, niobium, titanium niobium, mixtures thereof, alloys thereof, and combinations thereof.

Clause 109: The method of any one of clauses 105 to 107, wherein the seed layer is selected from the group consisting of titanium, titanium aluminum, niobium, stainless steel, mixtures thereof, alloys thereof, and combinations thereof.

Clause 110: The method of any one of clauses 105 to 109, wherein the seed layer comprises titanium.

Clause 111: The method of any one of clauses 105 to 109, wherein the seed layer comprises titanium aluminum.

Clause 112: The method of clause 111, wherein the seed layer comprises 40 wt. % to 60 wt. % titanium and 40 wt. % to 60 wt. % aluminum, such as such 45 wt. % to 55 wt. % titanium and 45 wt. % to 55 wt. % aluminum, or such as 47 wt. % to 53 wt. % titanium and from 47 wt. % to 53 wt. % aluminum.

Clause 113: The method of clause 111, wherein the seed layer comprises 50 wt. % titanium and 50 wt. % aluminum.

Clause 114: The method of any of clauses 105 to 113, wherein the seed layer comprises a thickness in the range of from 0.5 nm to 3 nm, such as from 0.5 nm to 2.5 nm, or such as from 1 nm to 2 nm.

Clause 115: The method of any one of clauses 105 to 114, wherein the primer layer is selected from the group consisting of titanium, titanium aluminum, niobium, titanium niobium, stainless steel, mixtures thereof, alloys thereof, and combinations thereof.

Clause 116: The method of clause 109, wherein the primer layer is selected from the group consisting of titanium, titanium aluminum, niobium, nickel chromium, stainless steel, mixtures thereof, alloys thereof, and combinations thereof.

Clause 117: The method of any one of clauses 105 to 116, wherein the primer layer comprises niobium.

Clause 118: The method of any one of clauses 105 to 116, wherein the primer layer comprises titanium.

Clause 119: The method of any one of clauses 105 to 118, wherein the primer layer comprises a thickness of from 0.5 nm to 3 nm, such as from 0.5 nm to 2.5 nm, or such as from 1 nm to 2 nm.

Clause 120: The method of any one of clauses 105 to 119, wherein the first layer comprises zinc stannate, zinc oxide, aluminum zinc oxide, tin oxide, silicon nitride, silicon aluminum nitride, silicon oxynitride, silicon aluminum oxynitride, or mixtures thereof.

Clause 121: The method of any one of clauses 105 to 120, wherein the first layer comprises a thickness in the range of from 10 nm to 45 nm, such as from 20 nm to 35 nm, or such as from 25 nm to 30 nm.

Clause 122: The method of any one of clauses 105 to 121, wherein the metallic layer comprises a thickness of from 5 nm to 20 nm, such as from 5 nm to 15 nm, such as from 6 nm to 12 nm, or such as from 8 nm to 10 nm.

Clause 123: The method of any one of clauses 105 to 122, wherein the metallic layer comprises silver, gold, palladium, copper, mixtures thereof, alloys thereof, or combinations thereof.

Clause 124: The method of any one of clauses 105 to 122, wherein the metallic layer comprises silver.

Clause 125: The method of any one of clauses 105 to 124, wherein the metallic layer is a continuous metallic layer.

Clause 126: The method of any one of clauses 105 to 125, wherein the second layer comprises zinc stannate, zinc oxide, aluminum zinc oxide, tin oxide, silicon nitride, silicon aluminum nitride, silicon oxynitride, silicon aluminum oxynitride, or mixtures thereof.

Clause 127: The method of any one of clauses 105 to 126, wherein the second layer comprises a thickness in the range of from 25 nm to 50 nm, such as from 30 nm to 45 nm, such as from 35 nm to 42 nm, or such as from 38 nm to 42 nm.

Clause 128: The method of any one of clauses 105 to 127, wherein the seed layer comprises titanium aluminum; wherein the metallic layer comprises silver; and wherein the primer layer comprises niobium.

Clause 129: The method of any one of clauses 105 to 128, wherein the substrate is glass.

Clause 130: The method of any one of clauses 105 to 129, wherein the coated article is temperable.

Clause 131: A method of reducing haze in a coated article, the method comprising: providing a substrate comprising a first surface and a second surface opposite the first surface; forming a functional coating over at least a portion of the first surface or the second surface, wherein forming the functional coating comprises: positioning the substrate in a first chamber comprising a first atmosphere, wherein the first atmosphere comprises greater than 0 vol. % N₂ to less than or equal to 100 vol. % N₂ or greater than 0 vol. % O₂ to less than or equal to 80 vol. % O₂; applying a first layer in the first chamber under the first atmosphere over at least a portion of the substrate; moving the substrate into a second chamber comprising a second atmosphere, wherein the second atmosphere comprises not greater than 15 vol. % N₂ and not greater than 5 vol. % O₂; applying a seed layer in the second chamber under the second atmosphere over and in direct contact with at least a portion of the first layer, wherein the seed layer is selected from the group consisting of titanium, titanium aluminum, niobium, titanium niobium, stainless steel, mixtures thereof, alloys thereof, and combinations thereof; moving the substrate into a third chamber comprising a third atmosphere, wherein the third atmosphere comprises not greater than 15 vol. % N₂ and not greater than 5 vol. % O₂; applying a metallic layer in the third chamber under the third atmosphere over and in direct contact with at least a portion of the seed layer; moving the substrate into a fourth chamber comprising a fourth atmosphere, wherein the fourth atmosphere comprises not greater than 15 vol. % N₂ and not greater than 5 vol. % O₂; applying a primer layer in the fourth chamber under the fourth atmosphere over and in direct contact with at least a portion of the metallic layer, wherein the primer layer is selected from the group consisting of titanium, titanium aluminum, niobium, titanium niobium, nickel chromium, stainless steel, mixtures thereof, alloys thereof, and combinations thereof; moving the substrate into a fifth chamber comprising a fifth atmosphere, wherein the fifth atmosphere comprises greater than 0 vol. % N₂ to less than or equal to 100 vol. % N₂ or greater than 0 vol. % O₂ to less than or equal to 80 vol. % O₂; and applying a second layer in the fifth chamber under the fifth atmosphere over and in direct contact with at least a portion of the primer layer; and heating the coated article to a temperature of greater than or equal to 1,000° F., wherein the coated article has reduced haze after heating to a temperature of greater than or equal to 1,000° F.

Clause 132: The method of clause 131, wherein the seed layer, the metallic layer, and the primer layer are deposited in an atmosphere that comprises not greater than 10 vol. % N₂ or not greater than 5 vol. % N₂ and not greater than 2 vol. % O₂ or not greater than 1 vol. % O₂.

Clause 133: The method of clause 131 or 132, wherein the functional coating consists of the first layer, the seed layer, the metallic layer, the primer layer, and the second layer.

Clause 134: The method of any one of clauses 131 to 133, wherein the seed layer is selected from the group consisting of titanium, titanium aluminum, niobium, titanium niobium, mixtures thereof, alloys thereof, and combinations thereof.

Clause 135: The method of any one of clauses 131 to 133, wherein the seed layer is selected from the group consisting of titanium, titanium aluminum, niobium, stainless steel, mixtures thereof, alloys thereof, and combinations thereof.

Clause 136: The method of any one of clauses 131 to 135, wherein the seed layer comprises titanium.

Clause 137: The method of any one of clauses 131 to 135, wherein the seed layer comprises titanium aluminum.

Clause 138: The method of clause 137, wherein the seed layer comprises 40 wt. % to 60 wt. % titanium and 40 wt. % to 60 wt. % aluminum, such as such 45 wt. % to 55 wt. % titanium and 45 wt. % to 55 wt. % aluminum, or such as 47 wt. % to 53 wt. % titanium and from 47 wt. % to 53 wt. % aluminum.

Clause 139: The method of clause 137, wherein the seed layer comprises 50 wt. % titanium and 50 wt. % aluminum.

Clause 140: The method of any of clauses 131 to 139, wherein the seed layer comprises a thickness in the range of from 0.5 nm to 3 nm, such as from 0.5 nm to 2.5 nm, or such as from 1 nm to 2 nm.

Clause 141: The method of any one of clauses 131 to 140, wherein the primer layer is selected from the group consisting of titanium, titanium aluminum, niobium, titanium niobium, stainless steel, mixtures thereof, alloys thereof, and combinations thereof.

Clause 142: The method of clause 135, wherein the primer layer is selected from the group consisting of titanium, titanium aluminum, niobium, nickel chromium, stainless steel, mixtures thereof, alloys thereof, and combinations thereof.

Clause 143: The method of any one of clauses 131 to 142, wherein the primer layer comprises niobium.

Clause 144: The method of any one of clauses 131 to 142, wherein the primer layer comprises titanium.

Clause 145: The method of any one of clauses 131 to 144, wherein the primer layer comprises a thickness of from 0.5 nm to 3 nm, such as from 0.5 nm to 2.5 nm, or such as from 1 nm to 2 nm.

Clause 146: The method of any one of clauses 131 to 145, wherein the first layer comprises zinc stannate, zinc oxide, aluminum zinc oxide, tin oxide, silicon nitride, silicon aluminum nitride, silicon oxynitride, silicon aluminum oxynitride, or mixtures thereof.

Clause 147: The method of any one of clauses 131 to 146, wherein the first layer comprises a thickness in the range of from 10 nm to 45 nm, such as from 20 nm to 35 nm, or such as from 25 nm to 30 nm.

Clause 148: The method of any one of clauses 131 to 147, wherein the metallic layer comprises a thickness of from 5 nm to 20 nm, such as from 5 nm to 15 nm, such as from 6 nm to 12 nm, or such as from 8 nm to 10 nm.

Clause 149: The method of any one of clauses 131 to 148, wherein the metallic layer comprises silver, gold, palladium, copper, mixtures thereof, alloys thereof, or combinations thereof.

Clause 150: The method of any one of clauses 131 to 148, wherein the metallic layer comprises silver.

Clause 151: The method of any one of clauses 131 to 150, wherein the metallic layer is a continuous metallic layer.

Clause 152: The method of any one of clauses 131 to 151, wherein the second layer comprises zinc stannate, zinc oxide, aluminum zinc oxide, tin oxide, silicon nitride, silicon aluminum nitride, silicon oxynitride, silicon aluminum oxynitride, or mixtures thereof.

Clause 153: The method of any one of clauses 131 to 152, wherein the second layer comprises a thickness in the range of from 25 nm to 50 nm, such as from 30 nm to 45 nm, such as from 35 nm to 42 nm, or such as from 38 nm to 42 nm.

Clause 154: The method of any one of clauses 131 to 153, wherein the seed layer comprises titanium aluminum; wherein the metallic layer comprises silver; and wherein the primer layer comprises niobium.

Clause 155: The method of any one of clauses 131 to 154, wherein the substrate is glass.

Clause 156: The method of any one of clauses 131 to 155, wherein the coated article is temperable.

Clause 157: The method of any one of clauses 131 to 156, wherein the coated article has reduced haze as compared to a coated article having a different seed layer and a different primer layer or a coated article without a seed layer and without a primer layer.

### EXAMPLES

### Example 1

A clear monolithic glass substrate was coated with a functional coating to form the coated article of Sample 1, as provided in Table 1. The seed layer was titanium aluminum having 50 wt. % titanium and 50 wt. % aluminum (designated as Ti50Al). The primer layer was niobium (Nb). Silicon aluminum nitride is designated as SiAlN and silver is designated as Ag in Table 1. The seed layer, the metallic layer, and the primer layer were deposited in a 5 vol. % N₂ atmosphere, where the remainder of the atmosphere was argon. There may have been some O₂ present in the atmosphere. It was uncertain how much O₂ was present but the estimates are 0 vol. % O₂ and at most 5 vol. % O₂. The thicknesses of the layers are in nanometers (nm), unless otherwise noted.

TABLE 1

| Sample | Layer | Composition | Thickness |
|---|---|---|---|
| Sample 1 | Substrate | Clear Glass | 6 mm |
| | 1^{st} Layer | SiAIN | 28 nm |
| | Seed Layer | Ti50Al | 1 nm |
| | Metallic Layer | Ag | 8 nm |
| | Primer Layer | Nb | 2 nm |
| | 2^{nd} Layer | SiAIN | 40 nm |

The optical properties of the coated article of Sample 1 were evaluated, as described above, and the results can be found in Table 2.

TABLE 2

| Sample | T L* | T a* | T b* | Rf L* | Rf a* | Rf b* | Rg L* | Rg a* | Rg b* |
|---|---|---|---|---|---|---|---|---|---|
| 1 | 80.16 | −2.72 | −4.54 | 31.34 | 7.34 | 13.39 | 34.87 | 2.97 | −4.80 |

### Example 2

The coated articles of Samples 2-5 were prepared by applying the functional coating as provided in Table 3. The substrates of Samples 2-5 were clear 6 mm thick monolithic glass substrates. The seed layers, metallic layers, and the primer layers were deposited in either a 0 vol. % N₂ atmosphere (Sample 2), a 5 vol. % N₂ atmosphere (Sample 3), a 10 vol. % N₂ atmosphere (Sample 4), or a 15 vol. % N₂ atmosphere (Sample 5). The remainder of the atmosphere was argon. There may have been some O₂ present in the atmosphere. It was uncertain how much O₂ was present but the estimates are 0 vol. % O₂ and at most 2 vol. % O₂.

TABLE 3

| Layer | Composition | Thickness (nm) |
|---|---|---|
| 1^{st} Layer | SiAIN | 28 nm |
| Seed Layer | Ti50Al | 1 nm |
| Metallic Layer | Ag | 8 nm |
| Primer Layer | Nb | 2 nm |
| 2^{nd} Layer | SiAIN | 40 nm |

The sheet resistance of the coated articles of Samples 2-5 were evaluated and the results can be found in Table 4. The coated articles of Samples 2-5 had acceptable visual quality and acceptable haze.

TABLE 4

| Sample | Sheet Resistance (Ω/▭) |
|---|---|
| 2 | 10.70 |
| 3 | 8.88 |
| 4 | 7.09 |
| 5 | 28.53 |

### Example 3

The coated articles of Samples 6 and 7 were prepared by applying the functional coating as provided in Table 3. The seed layers, metallic layers, and the primer layers were deposited in an argon atmosphere. There may have been some N₂ and O₂ present in the atmosphere. It was uncertain how much N₂ was present, but the estimates are at least 2 vol. % N₂ and at most 8 vol. % N₂. It was uncertain how much O₂ was present but the estimates are 0 vol. % O₂ and at most 2 vol. % O₂. The substrates of Samples 6 and 7 were clear 3.1 mm thick monolithic glass substrates. The coated article of Sample 6 was not heat treated. The coated article of Sample 7 was heat treated to achieve a glass surface temperature of 1,185° F.±3-4° F.

The resulting spectral properties of Samples 6 and 7 can be found in Table 5.

TABLE 5

| Sample | Emissivity | T L* | T a* | T b* | Rf L* | Rf a* | Rf b* | Rg L* | Rg a* | Rg b* |
|---|---|---|---|---|---|---|---|---|---|---|
| 6 | 0.16 | 67.57 | −2.12 | −2.60 | 44.39 | 5.47 | 18.37 | 46.34 | 0.94 | −1.63 |
| 7 | 0.16 | 80.96 | −2.75 | −4.09 | 32.04 | 7.11 | 10.39 | 35.74 | 2.78 | −4.81 |

### Example 4

Insulating glass units were prepared using the coated articles of Samples 6 and 7, as described above in Example 3. The second glass ply of the insulating glass unit was a clear glass ply having a thickness of 3 mm and was uncoated. The first glass ply and the second glass ply were spaced 1.5 inches apart and the space between the first and second glass plies was filled with air. The functional coating was on the No. 2 surface of the first glass play. The insulating glass units were tested to determine the spectral properties (Table 6) and the performance properties, such as visible light transmittance (VLT), visible exterior reflectance (Refl. Ext.), visible interior reflectance (Refl. Int.), SC, SHGC, LSG, and the summer/day and winter/night U-factors (Table 7). The insulating glass unit having the un-tempered coated glass ply of Sample 6 is designated as Sample 8 in Tables 6 and 7 and the insulating glass unit having the tempered coated glass ply of Sample 7 is designated as Sample 9 in Tables 6 and 7.

TABLE 6

| Sample | T L* | T a* | T b* | Rf L* | Rf a* | Rf b* | Rg L* | Rg a* | Rg b* |
|---|---|---|---|---|---|---|---|---|---|
| 8 | 64.98 | −2.71 | −2.17 | 51.99 | 2.58 | 10.22 | 47.94 | 0.63 | −1.92 |
| 9 | 77.77 | −3.42 | −3.72 | 44.77 | 2.86 | 4.09 | 40.96 | 1.44 | −5.43 |

TABLE 7

| | | | | | | | U | U | U | U |
|---|---|---|---|---|---|---|---|---|---|---|
| | | Refl. | Refl. | | | | Sum | Winter | Sum | Winter |
| | VLT | Ext. | Int. | | | | W/m² | W/m² | Btu | Btu |
| Sample | (%) | (%) | (%) | SC | SHGC | LSG | K | K | (hr × ft²) | (hr × ft²) |
| 8 | 33.9 | 16.7 | 20.4 | 0.35 | 0.30 | 1.12 | 1.87 | 1.89 | 0.33 | 0.33 |
| 9 | 52.6 | 11.7 | 14.5 | 0.48 | 0.42 | 1.27 | 1.88 | 1.90 | 0.33 | 0.34 |

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. A method of making a coated article, the method comprising:
providing a substrate comprising a first surface and a second surface opposite the first surface; and
forming a functional coating over at least a portion of the first surface or the second surface, wherein forming the functional coating comprises:
positioning the substrate in a first chamber comprising a first atmosphere, wherein the first atmosphere comprises greater than 0 vol. % N₂ to less than or equal to 100 vol. % N₂ or greater than 0 vol. % O₂ to less than or equal to 80 vol. % O₂;
applying a first layer in the first chamber under the first atmosphere over at least a portion of the substrate;
moving the substrate into a second chamber comprising a second atmosphere, wherein the second atmosphere comprises not greater than 15 vol. % N₂ and not greater than 5 vol. % O₂;
applying a seed layer in the second chamber under the second atmosphere over and in direct contact with at least a portion of the first layer, wherein the seed layer is selected from the group consisting of titanium, titanium aluminum, niobium, titanium niobium, stainless steel, mixtures thereof, alloys thereof, and combinations thereof;
moving the substrate into a third chamber comprising a third atmosphere, wherein the third atmosphere comprises not greater than 15 vol. % N₂ and not greater than 5 vol. % O₂;
applying a metallic layer in the third chamber under the third atmosphere over and in direct contact with at least a portion of the seed layer;
moving the substrate into a fourth chamber comprising a fourth atmosphere, wherein the fourth atmosphere comprises not greater than 15 vol. % N₂ and not greater than 5 vol. % O₂;
applying a primer layer in the fourth chamber under the fourth atmosphere over and in direct contact with at least a portion of the metallic layer, wherein the primer layer is selected from the group consisting of titanium, titanium aluminum, niobium, titanium niobium, nickel chromium, stainless steel, mixtures thereof, alloys thereof, and combinations thereof;
moving the substrate into a fifth chamber comprising a fifth atmosphere, wherein the fifth atmosphere comprises greater than 0 vol. % N₂ to less than or equal to 100 vol. % N₂ or greater than 0 vol. % O₂ to less than or equal to 80 vol. % O₂; and
applying a second layer in the fifth chamber under the fifth atmosphere over and in direct contact with at least a portion of the primer layer.

2. The method of claim 1, wherein the seed layer, the metallic layer, and the primer layer are deposited in an atmosphere that comprises not greater than 10 vol. % N₂ or not greater than 5 vol. % N₂ and not greater than 2 vol. % O₂ or not greater than 1 vol. % O₂.

3. The method of claim 1, wherein the functional coating consists of the first layer, the seed layer, the metallic layer, the primer layer, and the second layer.

4. The method of claim 1, wherein the seed layer is selected from the group consisting of titanium, titanium aluminum, niobium, stainless steel, mixtures thereof, alloys thereof, and combinations thereof.

5. The method of claim 1, wherein the seed layer comprises titanium aluminum.

6. The method of claim 3, wherein the seed layer comprises 40 wt. % to 60 wt. % titanium and 40 wt. % to 60 wt. % aluminum.

7. The method of claim 1, wherein the seed layer comprises a thickness in the range of from 0.5 nm to 3 nm.

8. The method of claim 4, wherein the primer layer is selected from the group consisting of titanium, titanium aluminum, niobium, nickel chromium, stainless steel, mixtures thereof, alloys thereof, and combinations thereof.

9. The method of claim 1, wherein the primer layer comprises niobium.

10. The method of claim 1, wherein the primer layer comprises titanium.

11. The method of claim 1, wherein the primer layer comprises a thickness of from 0.5 nm to 3 nm.

12. The method of claim 1, wherein the first layer comprises zinc stannate, zinc oxide, aluminum zinc oxide, tin oxide, silicon nitride, silicon aluminum nitride, silicon oxynitride, silicon aluminum oxynitride, or mixtures thereof.

13. The method of claim 1, wherein the first layer comprises a thickness in the range of from 10 nm to 45 nm.

14. The method of claim 1, wherein the metallic layer comprises a thickness of from 5 nm to 20 nm.

15. The method of claim 1, wherein the metallic layer comprises silver, gold, palladium, copper, mixtures thereof, alloys thereof, or combinations thereof.

16. The method of claim 1, wherein the metallic layer comprises silver.

17. The method of claim 1, wherein the second layer comprises zinc stannate, zinc oxide, aluminum zinc oxide, tin oxide, silicon nitride, silicon aluminum nitride, silicon oxynitride, silicon aluminum oxynitride, or mixtures thereof.

18. The method of claim 1, wherein the seed layer comprises titanium aluminum;
wherein the metallic layer comprises silver; and
wherein the primer layer comprises niobium.

19. A coated article comprising:
a substrate comprising a first surface and a second surface opposite the first surface; and
a functional coating applied over at least a portion of the first surface or the second surface of the substrate, the functional coating comprising:
a first layer positioned over at least a portion of the substrate;
a seed layer positioned over and in direct contact with at least a portion of the first layer, wherein the seed layer is selected from the group consisting of titanium, titanium aluminum, niobium, titanium niobium, stainless steel, mixtures thereof, alloys thereof, and combinations thereof;
a metallic layer positioned over and in direct contact with at least a portion of the seed layer;
a primer layer positioned over and in direct contact with at least a portion of the metallic layer, wherein the primer layer is selected from the group consisting of titanium, titanium aluminum, niobium, titanium niobium, nickel chromium, stainless steel, mixtures thereof, alloys thereof, and combinations thereof; and
a second layer positioned over and in direct contact with at least a portion of the primer layer.

20. A method of protecting a metallic layer in a coated article, the method comprising:
providing a substrate comprising a first surface and a second surface opposite the first surface; and
forming a functional coating over at least a portion of the first surface or the second surface, wherein forming the functional coating comprises:
positioning the substrate in a first chamber comprising a first atmosphere, wherein the first atmosphere comprises greater than 0 vol. % N₂ to less than or equal to 100 vol. % N₂ or greater than 0 vol. % O₂ to less than or equal to 80 vol. % O₂;
applying a first layer in the first chamber under the first atmosphere over at least a portion of the substrate;
moving the substrate into a second chamber comprising a second atmosphere, wherein the second atmosphere comprises not greater than 15 vol. % N₂ and not greater than 5 vol. % O₂;
applying a seed layer in the second chamber under the second atmosphere over and in direct contact with at least a portion of the first layer, wherein the seed layer is selected from the group consisting of titanium, titanium aluminum, niobium, titanium niobium, stainless steel, mixtures thereof, alloys thereof, and combinations thereof;
moving the substrate into a third chamber comprising a third atmosphere, wherein the third atmosphere comprises not greater than 15 vol. % N₂ and not greater than 5 vol. % O₂;
applying a metallic layer in the third chamber under the third atmosphere over and in direct contact with at least a portion of the seed layer;
moving the substrate into a fourth chamber comprising a fourth atmosphere, wherein the fourth atmosphere comprises not greater than 15 vol. % N₂ and not greater than 5 vol. % O₂;
applying a primer layer in the fourth chamber under the fourth atmosphere over and in direct contact with at least a portion of the metallic layer, wherein the primer layer is selected from the group consisting of titanium, titanium aluminum, niobium, titanium niobium, nickel chromium, stainless steel, mixtures thereof, alloys thereof, and combinations thereof;
moving the substrate into a fifth chamber comprising a fifth atmosphere, wherein the fifth atmosphere comprises greater than 0 vol. % N₂ to less than or equal to 100 vol. % N₂ or greater than 0 vol. % O₂ to less than or equal to 80 vol. % O₂; and
applying a second layer in the fifth chamber under the fifth atmosphere over and in direct contact with at least a portion of the primer layer.
